(19) United States
(12) Patent Application Publication
(10) Pub. No.: US 2026/0365226 A1
(43) Pub. Date: Nov. 19, 2026

(54) METHODS AND APPARATUS TO ADJUST A STEERING ANGLE OF A VEHICLE IN A SELF-DRIVING MODE

(71) Applicant: Ford Global Technologies, LLC, Dearborn, MI (US)

(72) Inventors: Ashrit Das, Canton, MI (US); Anand Pradip Naik, Bloomfield Hills, MI (US)

(21) Appl. No.: 19/209,525

(22) Filed: May 15, 2025

(51) Int. Cl. B62D 1/28; B62D 5/04; B62D 6/00; B62D 15/02

(52) U.S. Cl. CPC B62D 1/283; B62D 5/0421; B62D 5/0463; B62D 6/002; B62D 15/0215

(57) ABSTRACT

Methods and apparatus to adjust a steering angle of a vehicle in a self-driving mode are described herein. An example vehicle disclosed herein includes a torque sensor operatively coupled to a steering wheel, the torque sensor to sense a torque input to the steering wheel by a driver, programmable circuitry to execute the instructions to access a path follower (PF) angle request, condition the PF angle request to obtain a conditioned PF angle request based on the torque input, determine a final angle request based on the conditioned PF angle request, and convert the final angle request to a torque request to be used to adjust the steering angle via the steering motor.

### FIELD OF THE DISCLOSURE

This disclosure relates generally to vehicle control and, more particularly, to methods and apparatus to adjust a steering angle of a vehicle in a self-driving mode.

### BACKGROUND

In recent years, some vehicles have been outfitted with automated driving systems that can automatically drive or steer the vehicle in a self-driving mode. These systems include a path follower controller that analyzes the road ahead (e.g., using one or more cameras and or Map based systems) and determines how to steer the vehicle along a target path based on the analysis. The path follower controller determines a torque to be applied by a steering motor to the steering system to steer the vehicle. In some instances, while in the self-driving mode, the driver may still need to manually steer the vehicle.

### SUMMARY

An example vehicle disclosed herein includes a steering wheel, a torque sensor operatively coupled to the steering wheel, the torque sensor to sense a torque input to the steering wheel by a driver, a steerable wheel, the steering wheel operatively coupled to the steerable wheel, and a steering motor to be activated to control a steering angle of the steering wheel while the vehicle is in a self-driving mode. The vehicle also includes programmable circuitry to execute instructions to: access a path follower (PF) angle request; condition the PF angle request to obtain a conditioned PF angle request based on the torque input, determine a final angle request based on the conditioned PF angle request, and convert the final angle request to a torque request to be used to adjust the steering angle via the steering motor.

Disclosed herein is an example non-transitory machine readable storage medium that includes instructions to cause programmable circuitry to at least: access a path follower (PF) angle request, condition the PF angle request to obtain a conditioned PF angle request based on a torque input to a steering wheel by a driver, determine a final angle request based on the conditioned PF angle request, and convert the final angle request to a torque request to be used to adjust a steering angle of the steering wheel while the vehicle is in an assisted driving mode.

An example method disclosed herein includes accessing a path follower (PF) angle request, determining a final angle request based on the conditioned PF angle request, and converting the final angle request to a torque request to be used to adjust a steering angle of the steering wheel while the vehicle is in an assisted driving mode.

### BRIEF DESCRIPTION OF THE DRAWINGS

FIG. 1 illustrates an example vehicle in which the example methods and apparatus disclosed herein can be implemented.

FIG. 2A is a schematic of an example steering system of the example vehicle of FIG. 1 including an example electronic control unit including an example steering controller used to steer the vehicle in a self-driving mode.

FIG. 2B is a schematic of another example steering system of the example vehicle of FIG. 1 including an example electronic control unit including an example steering controller used to steer the vehicle in a self-driving mode.

FIG. 3 is a block diagram of the example steering controller of FIGS. 2A-2B.

FIG. 4 is a block diagram of an example implementation of virtual boost curve circuitry of the example steering controller of FIG. 3 that is used to generate a virtual boost curve angle request.

FIG. 5 is a block diagram of an example implementation of angle blending circuitry of the example steering controller of FIG. 3 that is used to generate a final angle request.

FIG. 6 illustrates an example final angle generation operation for determining an example final angle request.

FIG. 7 illustrates an example angle blending weight generation operation for determining an example angle blending weight.

FIG. 8 is an example chart that represents example values of an angle blending weight based on the operation of FIG. 7.

FIG. 9 illustrates an example virtual boost curve angle request generation operation for determining a virtual boost curve angle request.

FIG. 10 illustrates an example main incremental angle generation operation for determining an example main incremental angle.

FIG. 11 illustrates an example derivative incremental angle generation operation for determining an example derivative incremental angle.

FIG. 12 is an example first derivative incremental angle chart representative of the example derivative incremental angle generation operation of FIG. 11.

FIG. 13 illustrates an example return to center incremental angle generation operation for determining an example return to center incremental angle.

FIG. 14 illustrates an example return to center reference generation operation for determining an example return to center reference.

FIG. 15 illustrates an example damping incremental angle generation operation for determining an example damping incremental angle.

FIG. 16 is a block diagram of an example implementation of path follower conditioning circuitry that operates in connection with the steering controller of FIGS. 2A-2B and 3.

FIG. 17 illustrates an example path follower angle request conditioning operation.

FIG. 18 is a flowchart representative of example machine readable instructions and/or example operations that may be executed, instantiated, and/or performed by example programmable circuitry to implement the electronic control unit of FIGS. 2A-2B.

FIG. 19 is a flowchart representative of example machine readable instructions and/or example operations that may be executed, instantiated, and/or performed by example programmable circuitry to implement the example electronic control unit of FIGS. 2A-2B.

FIG. 20 is a flowchart representative of example machine readable instructions and/or example operations that may be executed, instantiated, and/or performed by example programmable circuitry to implement the example electronic control unit of FIGS. 2A-2B.

FIG. 21 is a block diagram of an example processing platform including programmable circuitry structured to execute, instantiate, and/or perform the example machine readable instructions and/or perform the example operations of FIGS. 18, 19, and/or 20 to implement the example electronic control unit of FIGS. 2A-2B.

In general, the same reference numbers will be used throughout the drawing(s) and accompanying written description to refer to the same or like parts. The figures are not necessarily to scale.

### DETAILED DESCRIPTION

Most vehicles include a powered steering system that utilizes a motor, such as hydraulic motor or electric motor, to assist in applying torque to the steering system, and which reduces the torque input needed by the driver to steer the vehicle. In such vehicles, an electronic control unit utilizes a boost curve to determine an assistance torque to be applied to the motor based on driver torque input to a steering wheel. The boost curve defines a static relationship between the driver applied input torque and the assistance torque that the motor produces on the steerable wheels of the vehicle.

Vehicles disclosed herein have self-driving capabilities, referred to herein as a self-driving mode, path follower mode, or automated driving mode. When the vehicle is in the self-driving mode, path follower (PF) circuitry (e.g., a PF controller) of the electronic control unit determines a target path for the vehicle and provides a torque request to the motor to automatically control a yaw direction of the vehicle, thereby steering the vehicle along the target path. The PF circuitry receives sensor feedback, such as yaw values, and uses this feedback to further steer the vehicle along the target path. Furthermore, the assistance torque from the boost curve (e.g., based on the input torque from the driver) can be overlayed on the torque request from the PF circuitry. This allows the driver to still provide input and at least partially steer the vehicle while the vehicle is in the self-driving mode. As with power steering, the input torque applied to the steering wheel is equated, by the boost curve, to a larger torque to be applied by the motor. The torque value from the boost curve is combined with the torque from the PF circuitry input to the motor to steer the vehicle.

To provide stiffer and more robust lateral control, vehicles disclosed herein utilize a steering angle interface between the PF circuitry and the steering wheel input rather than a torque interface. In some disclosed examples, the PF circuitry calculates a steering angle to be achieved to cause the vehicle to stay on path, and then converts the steering angle to a torque to be applied by the motor to the steering wheel to achieve the steering angle. As used herein, the terms steering angle and steering wheel angle (SWA) are used interchangeably and mean the angle the steering wheel has been rotated (e.g., by the driver) relative to a neutral or center position. As used herein, the term road wheel angle (RWA) means the angle the steerable wheels, such as the front two wheels, have been rotated (e.g., turned left or right) relative to a neutral or center position. Many of the example operations disclosed herein calculate a steering angle that is used to turn the steering wheel of the vehicle and thereby steer the vehicle. However, in most vehicles, the steering wheel is mechanically connected to the front wheels by a fixed gear relationship (e.g., via a rack and pinion). The geared relationship may be implemented as a fixed steering ratio or a variable steering ratio. For example, for every 12-20° the steering wheel is rotated, the front wheels are turned 1°, and vice versa. Therefore, any of the example operations disclosed herein can instead be described as calculating a road wheel angle, because the steering angle can be equated to the road wheel angle, and vice versa.

In some examples, the PF circuitry provides a PF angle request that corresponds to a target steering angle. However, this angle interface between the PF circuitry and the steering gear (e.g., steerable wheel, gear rack, etc.) imposes a difficulty in overlaying the driver input torque on the PF angle request. That is, the assistance torque from the boost curve cannot be easily combined with the PF angle request. Thus, in these angle-based follower platforms, the boost curve is typically deactivated during self-driving mode such that there is no torque overlay between the torque output of the angle control (e.g., PF circuitry) and the boost curve output. This increases robustness of the path follower operation of the vehicle because torque noise from amplification of the input torque is removed. However, this also presents a need for driver input to be overlayed at the angle request level rather than the torque level.

Disclosed herein are example electronic control units (ECUs) and associated methods that condition the PF angle request based on a torque input from a driver. As a result, examples disclosed herein enable a pushback torque encountered at a steering wheel to be based on different inputs when the driver is providing a dynamic torque input versus a static torque input. Specifically, examples disclosed herein enable the instantaneous SWA to have a greater effect in response to the driver providing dynamic torque inputs to provide the driver with a desirable control. Further, examples disclosed herein enable the PF angle request to have a greater effect in response to the driver providing static torque inputs to provide the driver with a torque pushback (e.g., resistance) for static maneuvers, such as steady state biasing in a driving lane.

Additionally, disclosed herein are example steering controllers and associated methods that use a virtual boost curve (VBC) to determine a steering angle, referred to herein as a VBC angle request, based on the driver torque input. In some examples, the steering controller determines a delta or incremental steering angle based on at least the driver torque input, and adds the delta angle to a current SWA to generate the VBC angle request. The example steering controller combines the VBC angle request with the PF angle request to generate a final steering angle request. Therefore, rather than a torque based boost curve output, the VBC is used to determine or output a steering angle, which is then combined with the PF angle request. An angle controller of the example steering controller converts the final steering angle request to a final torque request, which the motor of the steering system uses to adjust the steering angle of the steering wheel to steer the vehicle along the intended path.

In some examples, the steering controller includes VBC circuitry and/or implements a VBC method to enable manual steering while still being in the self-driving mode. The example steering controller disclosed herein uses the input torque (e.g., torsion bar (T-bar) torque) to generate an incremental angle, adds the incremental angle to the current SWA, and generates a VBC request that gets blended with the PF request and is used to generate a final angle request for the angle controller. In some examples, the torque source is the raw T-Bar torque and not a filtered torque, such as a Kalman filter based driver torque. That is, examples disclosed herein use a raw torque input to generate the VBC angle request because the lag associated with filtered torques creates a lag in the steering feel using the VBC. Examples disclosed herein also combine the VBC angle request with the PF angle request to generate the final angle request. In some examples, the VBC angle request and the PF angle request are combined after the VBC angle request is properly tuned.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

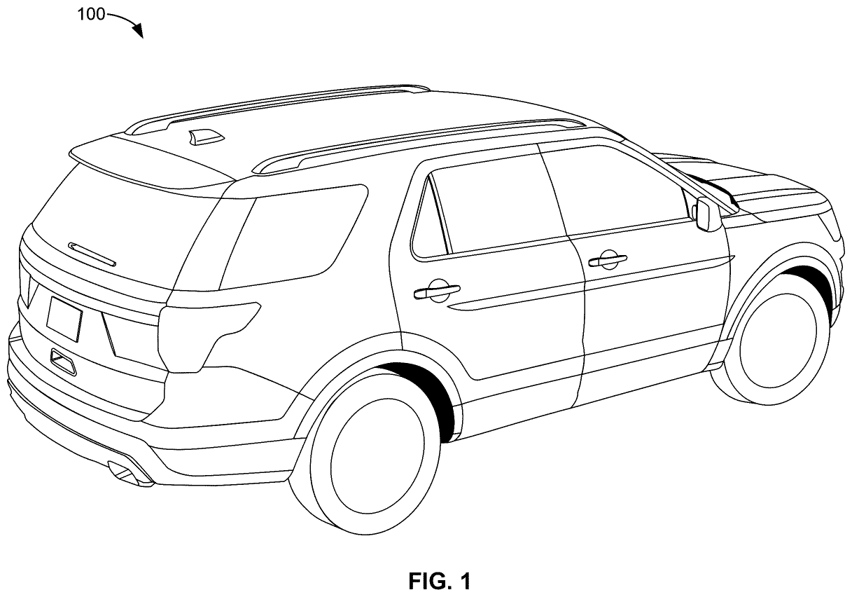

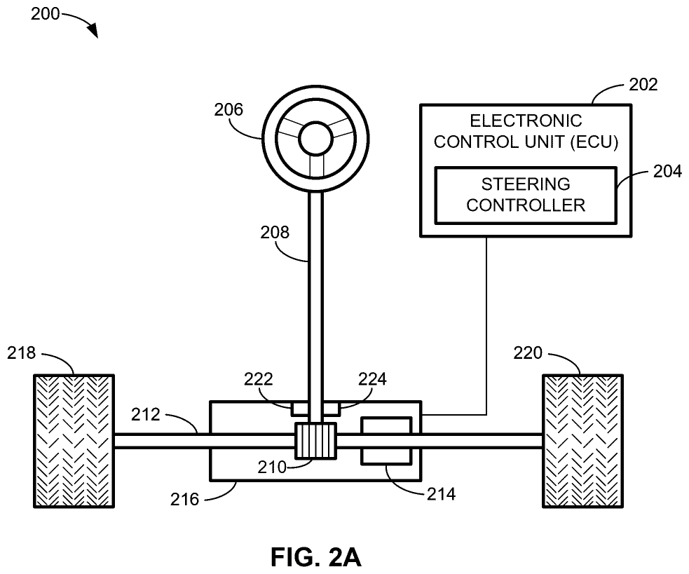

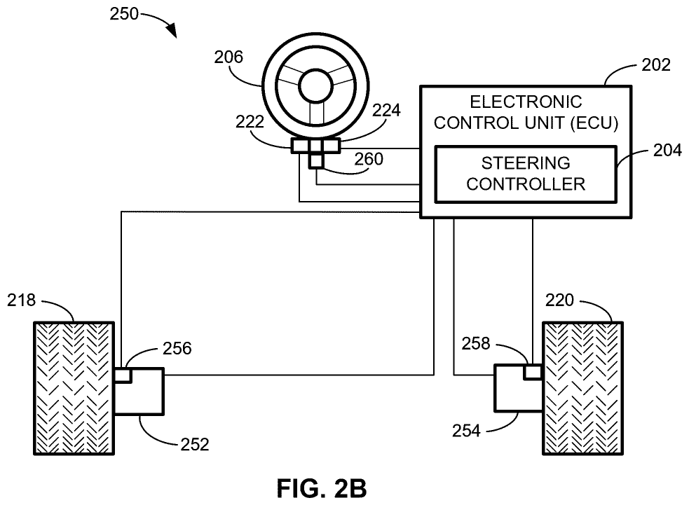

FIG. 1 illustrates an example vehicle 100 in which the examples disclosed herein can be implemented. The example vehicle 100 includes an example steering controller, shown in further detail herein, that can operate to automatically steer and/or direct the vehicle along a target path. Such automated operation is referred to herein as a path follower (PF) or self-driving mode or operation. In some examples, the self-driving mode can be activated and deactivated by the driver by pressing or a button and/or interacting with a display in the vehicle. During the self-driving mode, the steering controller of the vehicle 100 generates a PF angle request (e.g., independent of driver input) to direct the vehicle 100 along a target path. If the driver applies a torque input to the steering wheel of the vehicle 100, the steering controller generates a VBC angle request. The steering controller combines the VBC angle request with the PF angle request to generate a final angle request, and converts the final angle request to a torque request or output to be used to adjust the steering angle of the vehicle 100. Further description of the steering controller of the vehicle 100 is provided below in connection with FIGS. 2-18. The illustrated example of the vehicle 100 of FIG. 1 is merely an example of a sport utility vehicle (SUV) in which examples disclosed herein can be implemented. However, examples disclosed herein can also be implemented in connection with other types of vehicles (e.g., pickup trucks, sedans, semi-trucks, etc.).

FIG. 2A is a schematic illustration of an example steering system 200 that can be implemented in the example vehicle 100 of FIG. 1. In the illustrated example of FIG. 2A, the steering system 200 includes an electronic control unit 202 including a steering controller 204, a steering wheel 206, a steering column 208, a pinion 210, a gear rack 212, a steering motor 214, a housing 216, a first steerable wheel 218, a second steerable wheel 220, a torque sensor 222, and an SWA sensor 224. The example steering wheel 206 is mechanically connected to the first steerable wheel 218 and the second steerable wheel 220 (e.g., the front wheels of the vehicle 100 (FIG. 1). In particular, the steering wheel 206 is coupled to the first steerable wheel 218 and the second steerable wheel 220 via the steering column 208, the pinion 210, and the rack 212. Thus, as the driver of the vehicle 100 of FIG. 1 inputs torque to adjust the SWA of the steering wheel 206, the steering angle of the first and second steerable wheels 218, 220 is correspondingly adjusted (e.g., turned left or right). The rack and pinion 212, 210 may implement a fixed gear ratio or a variable gear ratio. In some examples, the steering column is a single shaft extending between the steering wheel 206 and the pinion 210. In other examples, the steering column 208 is a mechanical linkage including two or more interconnected shaft segments. For example, the steering column 208 can include a first steering shaft coupled to a second steering shaft via a universal joint (U-joint). Thus, the steering column 208 can be straight and/or angled between the steering wheel 206 and the steerable wheels 218, 220. In some examples, the vehicle 100 includes a steer-by-wire system, as discussed in connection with FIG. 2B.

In the illustrated example of FIG. 2A, the pinion 210 is coupled to and/or interfaces with the gear rack 212. For example, gear teeth of the pinion 210 are meshed with gear teeth of the gear rack 212. Thus, as the pinion 210 rotates based on the driver input torque to the steering wheel 206, the gear rack 212 translates laterally relative to the steering column 208. In some examples, the pinion 210 is positioned within the housing 216. In some examples, the pinion 210 is positioned outside of the housing 216.

In the illustrated example of FIG. 2A, the steering system 200 includes the motor 214. The motor 214 is operatively coupled to the steering wheel 206 and the first and second steerable wheels 218, 220. For example, the motor 214 can be coupled to the gear rack 212. When activated, the motor 214 moves or translates the gear rack 212, which thereby turns or angles the steering wheel 206 as well as the steerable wheels 218, 220. Thus, the motor 214 operates to adjust the steering angle of the steering wheel 206 and, thus, also adjusts the road wheel angle of the first and second steerable wheels 218, 220 to steer the vehicle 100. In some examples, the motor 214 can be used to provide power steering assistance. For example, in a traditional driving mode, based on torque input to the steering wheel 206, the electronic control unit 202 may activate the motor 214 to provide additional torque assistance for steering the vehicle 100. Additionally, the motor 214 can be activated to control the steering angle of the steering wheel 206 while the vehicle 100 is in a self-driving mode. As discussed in further detail herein, the steering controller 204 can provide a PF angle request and/or a torque request to the motor 214 to cause the motor 214 to adjust the steering angle accordingly.

The example steering controller 204 can operate in a self-driving mode to control the motor 214 and adjust the steering angle of the vehicle 100, example operations of which are disclosed in further detail herein. The steering controller 204 of FIG. 2A may be instantiated (e.g., creating an instance of, bring into being for any length of time, materialize, implement, etc.) by programmable circuitry such as a Central Processor Unit (CPU) executing first instructions. Additionally or alternatively, the steering controller 204 of FIG. 2A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2A may, thus, be instantiated at the same or different times. Some or all of the circuitry of FIG. 2A may be instantiated, for example, in one or more threads executing concurrently on hardware and/or in series on hardware. Moreover, in some examples, some or all of the circuitry of FIG. 2A may be implemented by microprocessor circuitry executing instructions and/or FPGA circuitry performing operations to implement one or more virtual machines and/or containers.

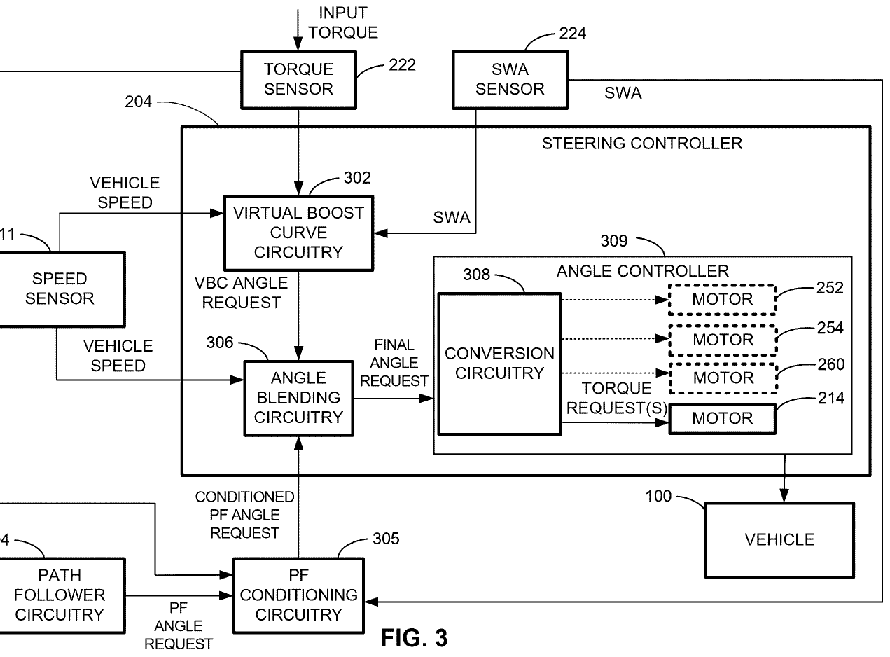

In some examples, the steering controller 204 of FIG. 2A includes instructions and programmable circuitry to execute the instructions to generate a virtual boost curve (VBC) angle request based on a torque input to a steering wheel 206 of the example vehicle 100 of FIG. 1. Furthermore, the steering controller 204 determines an angle blend weight based on the torque input and a speed of the vehicle 100. The example steering controller 204 can determine a final angle request based on a combination of the VBC angle request, a path follower (PF) angle request, and the angle blend weight. The example steering controller 204 converts the final angle request to a torque request to be used to adjust the steering angle of the vehicle 100. Further descriptions regarding the structure and operations of the steering controller 204 are described below in connection with FIGS. 3-18.

In the illustrated example of FIG. 2A, the steering system 200 includes the torque sensor 222 to detect or measure an input torque on the steering wheel 206. For example, when the driver turns or attempts to turn the steering wheel 206 during self-driving mode of the vehicle 100 of FIG. 1, the torque sensor 222 detects the torque input. As such, the driver may not be able to physically turn the steering wheel 206. However, the torque sensor 222 can still detect a torque applied at the steering wheel 206, which can then be converted into a desired steering angle, disclosed in further detail herein. In some examples, the steering controller 204 analyzes the sensor output to determine the torque input by the driver. The example torque sensor 222 can detect a static torque input at a point in time and/or a dynamic torque input over a period of time. As such, the torque sensor 222 can be a reaction torque sensor including a stationary or non-rotating transducer. The example torque sensor 222 can also be a rotary torque sensor including rotary transducers to measure torque input. In some examples, the torque sensor 222 is coupled to a torsion bar (T-bar) of the steering system 200. The torque on the T-bar can be equated to a torque applied at the steering wheel 206. In other examples, the torque sensor 222 is connected at another location of the steering system 200 (e.g., at the steering wheel 206).

In the illustrated example of FIG. 2A, the steering system 200 includes the SWA sensor 224 to detect a SWA of the steering wheel 206, the steering column 208, and/or the pinion 210. The example SWA sensor 224 can be coupled to the steering column 208 and/or the pinion 210 in a contacting or non-contacting arrangement. In some examples, the SWA sensor 224 is implemented as to a rotary position sensor, which enables precise angle measurements of the steering wheel 206. For example, the SWA sensor 224 can transform mechanical rotary positions into electrical signals. Thus, the example SWA sensor 224 can correspond to an incremental encoder or a rotary encoder that detects changes in SWA, angular velocity, and/or direction of rotation of the steering wheel 206. In some examples, the steering controller 204 obtains the SWA from the SWA sensor 224 in the form of a digital signal that the SWA sensor 224 (e.g., mechanical motion sensor) creates from a motion of the steering wheel 206, the steering column 208, and/or the pinion 210.

FIG. 2B is a schematic illustration of an example steering system 250 that can be implemented in the example vehicle 100 of FIG. 1. In the illustrated example of FIG. 2B, the steering system 250 includes the electronic control unit 202, the steering controller 204, the steering wheel 206, the first steerable wheel 218, the second steerable wheel 220, the torque sensor 222, and the SWA sensor 224 of FIG. 2A. The steering system 250 also includes a first steerable wheel motor 252, a second steerable wheel motor 254, a first steerable wheel position sensor 256, a second steerable wheel position sensor 258, and a torque feedback motor 260 (e.g., a steering wheel motor 260).

In the illustrated example of FIG. 2B, the torque sensor 222 and the SWA sensor are operatively coupled to the steering wheel 206 to detect or measure the input torque on the steering wheel 206 and the SWA of the steering wheel 206, respectively. The first steerable wheel motor 252 is operatively coupled to the first steerable wheel 218 to control and angular position thereof. The second steerable wheel 254 is operatively coupled to the second steerable wheel 220 to control an angular position thereof. The first steerable wheel motor 252 and the second steerable wheel motor 254 can be implemented by electric motors and/or electromechanical actuators. In some other examples, the first and second steerable wheel motors 252, 254 can be implemented by hydraulic motors.

In the illustrated example of FIG. 2B, the first steerable wheel position sensor 256 is operatively coupled to the first steerable wheel 218 and/or the first steerable wheel motor 252. The second steerable wheel position sensor 258 is operatively coupled to the second steerable wheel 220 and/or the second steerable wheel motor 254. The first steerable wheel positions sensors 256, 258 detect or measure an angular position and/or a rotational speed of the first and second steerable wheels 218, 220.

In the illustrated example of FIG. 2B, the torque feedback motor 260 is operatively coupled to the steering wheel 206 to provide torque feedback (e.g., steering feel). For example, the torque feedback motor 260 can be implemented by a motor operatively coupled to the steering wheel 206.

In the illustrated example of FIG. 2B, the ECU 202 identifies a driver input based on signals from the torque sensor 222 and/or the SWA sensor 224. The ECU 202 determines and transmits control signals to the first steerable wheel motor 252 and the second steerable wheel motor 254 based on the driver input. Additionally or alternatively, the ECU 202 can determine the control signals based on a final angle request determined by the steering controller 204, as discussed in further detail below. Further, the ECU 202 can monitor the first steerable wheel positions sensors 256, 258 for real-time feedback on the actual position and movement of the steerable wheels 218, 220 to ensure accurate and responsive steering is maintained. In some examples, the ECU 202 determines the torque feedback (e.g., amplitude and direction) to be provided by the torque feedback motor 260, as discussed in further detail below. In some examples, the ECU 202 causes the torque feedback motor 260 to adjust the SWA via the torque feedback motor 260 to match the final angle request in an assisted driving mode.

FIG. 3 is a block diagram of the steering controller 204 of FIGS. 2A-2B. When the vehicle 100 is in the self-driving mode, the steering controller 204 operates to control the motor 214 (FIG. 2A) or the first steerable wheel motor 252 (FIG. 2B), the second steerable wheel motor 254 (FIG. 2B), and/or the torque feedback motor 260 (FIG. 2B) to adjust the steering of the vehicle 100 and thereby steer the vehicle 100 along a target path. When the vehicle 100 includes the steering system 200 of FIG. 2A, the steering controller 204 includes or is in communication with the motor 214. When the vehicle 100 includes the steering system 250 of FIG. 2B, the steering controller 204 includes or is in communication with the first steerable wheel motor 252, the second steerable wheel motor 254, and/or the torque feedback motor 260. The steering controller 204 can also control the one or more of the motor(s) 214, 252, 254, 260 (and, thus, the steering angle) based on driver input torque during the self-driving mode, such as when the driver attempts to manually turn the steering wheel 206 (FIGS. 2A-2B). In some examples, the steering controller 204 is implemented in the electronic control unit 202 of FIGS. 2A-2B. Additionally or alternatively, the steering controller 204 can be implemented in another control system, control unit, and/or computing system of the vehicle 100.

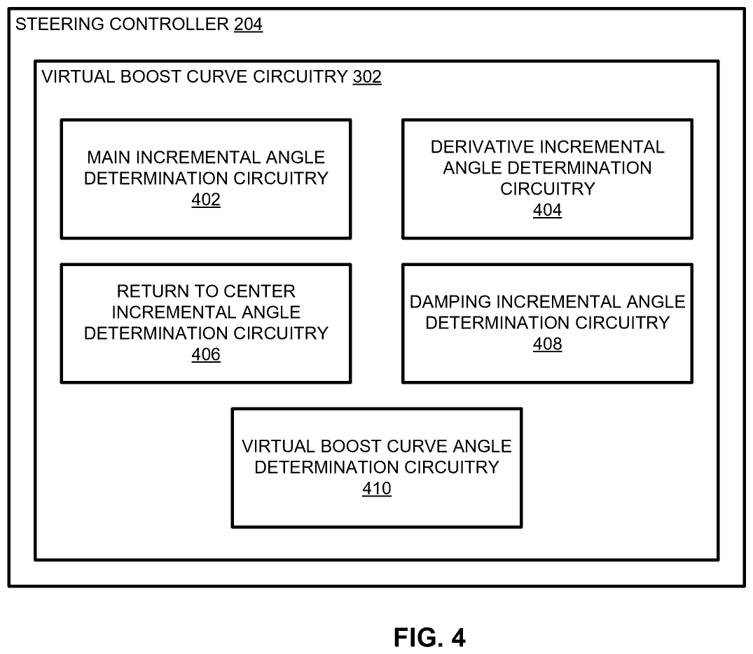

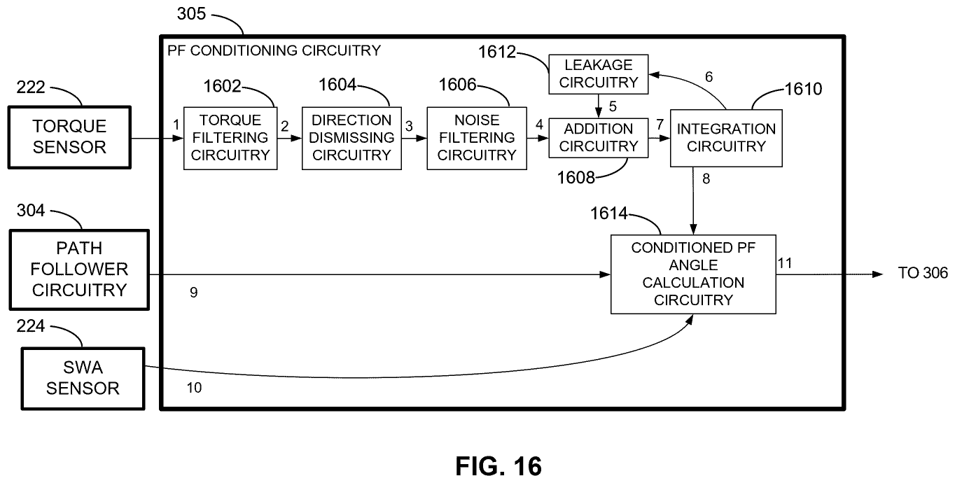

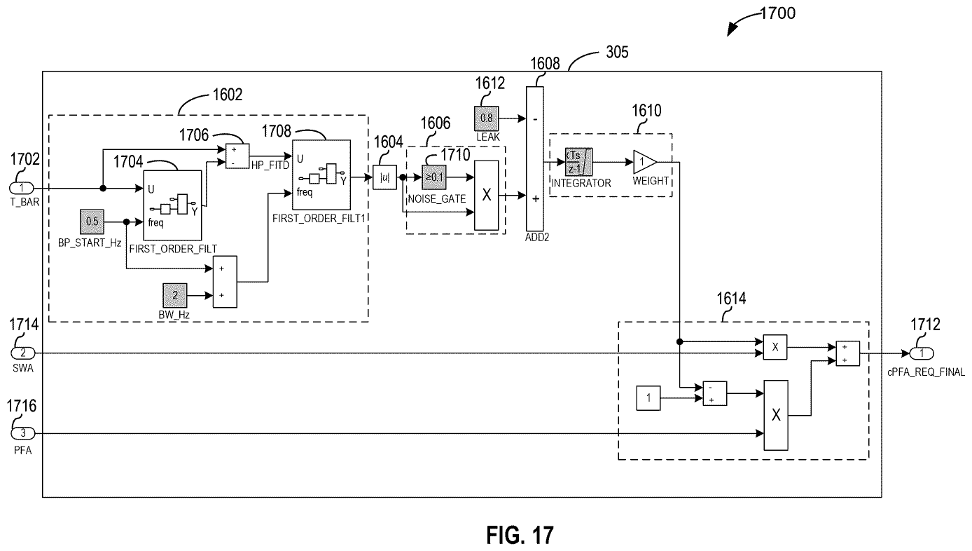

In the illustrated example of FIG. 3, the steering controller 204 includes example virtual boost curve circuitry 302 (VBC circuitry 302), example angle blending circuitry 306, and example conversion circuitry 308. The conversion circuitry 308 and the motor 214 (FIG. 2A) or the first steerable wheel motor 252, the second steerable wheel motor 254, and/or the torque feedback motor 260 (FIG. 2B) may be referred to as an angle controller 309. That is, when the vehicle 100 includes the steering system 200 of FIG. 2A, the angle controller 309 includes the motor 214. When the vehicle 100 includes the steering system 250 of FIG. 2B, the angle controller 309 includes the first steerable wheel motor 252, the second steerable wheel motor 254, and/or the torque feedback motor 260. As mentioned above, the torque sensor 222 outputs sensor signals corresponding to raw T-bar torque, which is indicative of driver input torque applied to with the steering wheel 206. The VBC circuitry 302 obtains the signals from the torque sensor 222, and determines an input torque using a Kalman filter approach and a model of the steering system 200, 250 of FIGS. 2A-2B. In other examples, a different type of filter may be used or unfiltered torque may be used. Furthermore, the VBC circuitry obtains a current SWA associated with the steering wheel 206 from the SWA sensor 224. The example VBC circuitry 302 determines a VBC angle request based on the input torque and the SWA. The VBC angle request represents a desired driver steering angle, which is based on the current SWA and driver torque applied to the steering wheel 206. In some examples, the VBC angle request is also based at least partially on vehicle speed, which may be measured by a speed sensor 311 of the vehicle 100. The VBC angle request includes a combination (e.g., summation) of an incremental angle and the current SWA. In some examples, the VBC circuitry 302 is instantiated by programmable circuitry executing VBC instructions and/or configured to perform operations such as those represented by the flowchart(s) of FIGS. 16 and 17. Further details on the VBC circuitry 302 and the VBC angle request are described below in connection with FIGS. 4 and 9-18.

When the vehicle 100 is in the self-driving mode, example path follower (PF) circuitry 304 determines a PF angle request, which is used to adjust the steering angle of the vehicle 100 to steer or direct the vehicle 100 along the target path. In FIG. 3 the PF circuitry 304 is shown as separate from the steering controller 204. For example, the PF circuitry 304 may be implemented by another controller of the ECU 202. However, in other examples, the PF circuitry 304 may be part of the steering controller 204. When the driver of the vehicle 100 does not interact with the steering wheel 206 (e.g., zero input torque) during the self-driving mode, the PF follower circuitry 304 controls the yaw, direction, and/or steering angle of the vehicle 100. For example, when the driver input torque is zero during the self-driving mode, the final angle request may include only the PF angle request. In some examples, the PF circuitry 304 determines the PF angle request based on a target path of the vehicle 100, a velocity of the vehicle 100, a current steering angle of the steering wheel 206 of FIGS. 2A-2B, and/or a projected path of the vehicle 100. In some examples, the PF circuitry 304 is instantiated by programmable circuitry executing PF instructions and/or configured to perform operations such as those represented by the flowchart(s) of FIG. 16.

In the illustrated example of FIG. 3, path follower conditioning circuitry 305 (PF conditioning circuitry 305) conditions the PF angle request from the PF circuitry 304. In FIG. 3 the PF conditioning circuitry 305 is shown as separate from the steering controller 204. For example, the PF conditioning circuitry 305 may be implemented by another controller of the ECU 202. However, in other examples, the PF conditioning circuitry 305 may be part of the steering controller 204. In the illustrated example of FIG. 3, the PF conditioning circuitry 305 is operatively coupled to the torque sensor 222 and the SWA sensor 224. The PF conditioning circuitry 305 conditions the PF angle request based on the input torque detected by the torque sensor 222. Further, the PF conditioning circuitry 305 communicates the conditioned PF angle request to the VBC circuitry 306 for consideration in the final angle request to be transmitted to the conversion circuitry 308 and/or one or more of the motor(s) 214, 252, 254, 260.

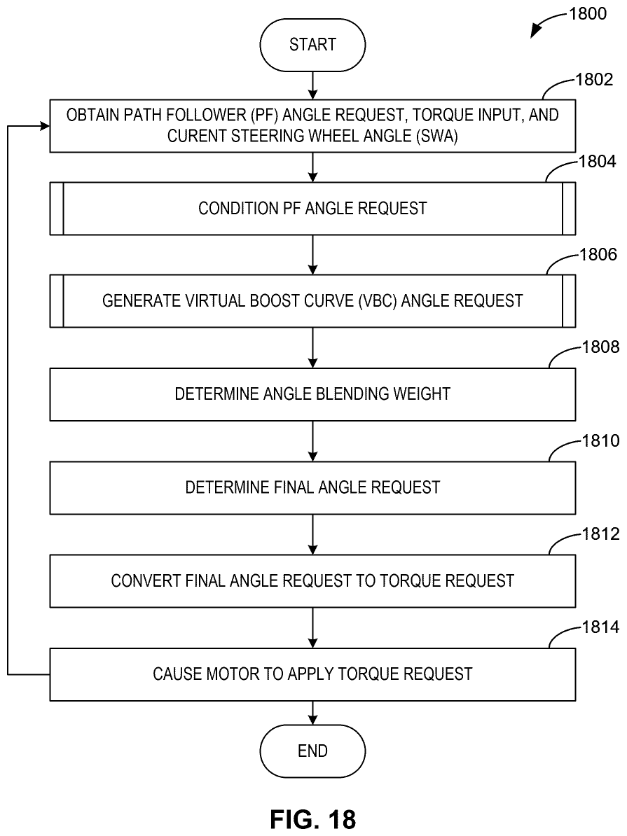

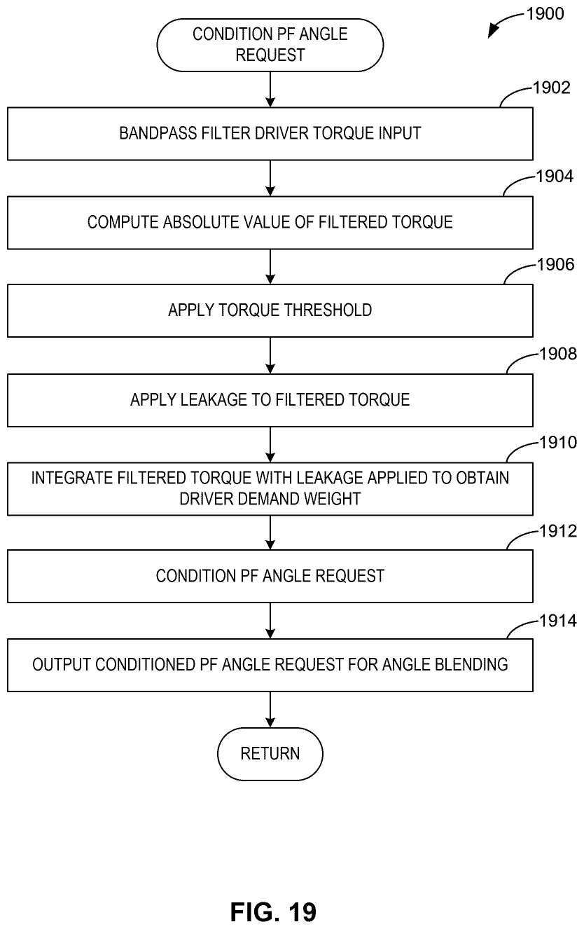

Further, the PF conditioning circuitry 305 determines a weight to be applied to the SWA and the PF angle request in the determination of the conditioned PF angle request based on the torque input. That is, the weight configures a first effect of the PF angle request on the final angle request and a second effect of the SWA on the final angle request. As a result, the PF conditioning circuitry 305 conditions the PF angle request to accommodate a desired angle from the driver while enabling the vehicle 100 to remain in an assisted driving mode. More particularly, an input torque above a driver interaction threshold can cause the vehicle 100 to exit an assisted driving mode, and thereby provide the driver of the vehicle 100 with full steering control. To prevent an undesired exit of the assisted driving mode while enabling a maneuver from the driver to have an increased effect on the final steering angle, the PF conditioning circuitry 305 causes some torque inputs that are below the driver interaction threshold to reduce the first effect of the PF angle request on the conditioned PF angle request and increase the second effect of the SWA on the conditioned PF angle request. Thus, the PF conditioning circuitry 305 dynamically weakens the PF angle request to increase the effect that the instantaneous SWA has on the conditioned PF angle request. In some examples, the PF conditioning circuitry 305 is instantiated by programmable circuitry executing angle blending instructions and/or configured to perform operations such as those represented by the flowcharts of FIGS. 18 and 19. Further detailed examples regarding the PF conditioning circuitry 305 and/or the conditioned PF angle are discussed in connection with FIGS. 16-17.

In the illustrated example of FIG. 3, the steering controller 204 includes the angle blending circuitry 306 to determine the final angle request based on a combination of the VBC angle request, the conditioned PF angle request, and an angle blending weight. In some examples, the angle blending weight is an internal signal that ranges in value from 0 to 1, where an angle blending weight of 0 corresponds to no driver input or interaction, and an angle blending weight of 1 corresponds to fully engaged driver interaction. Therefore, when the driver is not interacting (e.g., angle blending weight equals 0), angle control of the vehicle 100 is based solely the conditioned PF angle request, which corresponds to the PF angle request from the PF circuitry 304 in such scenarios.

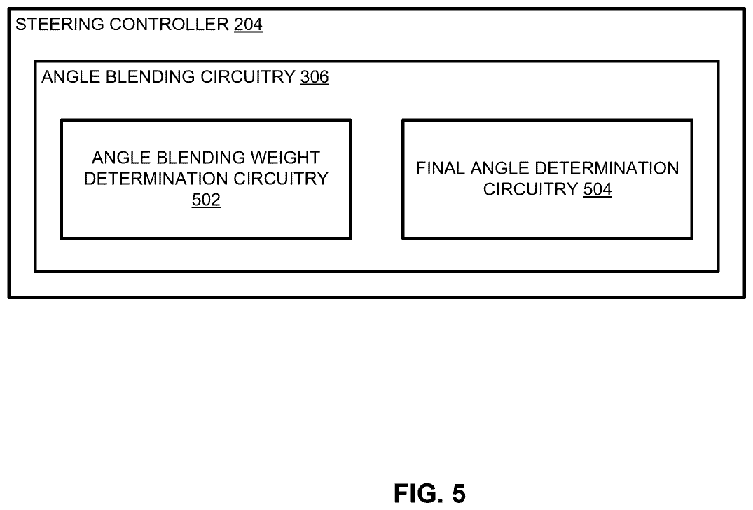

To generate the angle blending weight, the angle blending circuitry 306 can pass the driver input torque through a VBC weight lookup table, which provides a VBC weight (e.g., a preliminary weight) of 0 or 1. That is, when the input torque does not satisfy a VBC weight threshold, the preliminary weight is 0, and when the input torque does satisfy the VBC weight threshold, the preliminary weight is 1. Furthermore, the angle blending circuitry 306 multiplies the VBC weight by an output of a velocity based weight lookup table, which corresponds to a velocity based weight. The angle blending circuitry 306 may access the vehicle speed measured by the speed sensor 311. In some examples, the angle blending circuitry 306 inputs the vehicle speed to the velocity based weight lookup table to determine the velocity based weight. As the input vehicle speed increases, the output velocity based weight decreases. In some examples, the value of the angle blending weight and the contribution of VBC angle request is higher at lower speeds and lower at higher speeds. For example, as long as the driver input torque and the VBC weight is sufficiently high (e.g., a value of 1), at lower speeds the velocity based weight is higher, and at higher speeds the velocity based weight is lower. In some examples, the velocity based weight is 0 when the vehicle speed is about a threshold (e.g., 30 miles per hour (mph), 45 mph, 60 mph, etc.). In some examples, the angle blending circuitry 306 is instantiated by programmable circuitry executing angle blending instructions and/or configured to perform operations such as those represented by the flowchart(s) of FIG. 16. Further detailed examples regarding the angle blending circuitry 306 and/or the angle blending weight are discussed in connection with FIGS. 5-8.

In the illustrated example of FIG. 3, the steering controller 204 includes the conversion circuitry 308 to convert the final angle request to a torque request to be used to adjust the steering angle of the vehicle 100. For example, the conversion circuitry 308 can obtain the final angle request from the angle blending circuitry 306 and determine a torque to be applied by the motor 214 or the first steerable wheel motor 252, the second steerable wheel motor 254, and/or the torque feedback motor 260 to the steering system 200, 250 (e.g., to the gear rack 212, the pinion 210, the steering column 208, the first steerable wheel 218, the second steerable wheel 220, etc.) to achieve the steering angle associated with the final angle request. In some examples, the conversion circuitry 308 uses and/or generates a model of the steering system 200, 250 of FIGS. 2A-2B to convert the final angle request to the torque request. For example, the conversion circuitry 308 can account for size, geometry, orientation, material, structure, or other features of the steering system 200 to generate and/or implement the model. In some examples, the model used by the conversion circuitry 308 is generated based on the size and power of the motor 214, length and gear teeth spacing of the gear rack 212, diameter of the steering column 208, a size of the steerable wheels 218, 220, the power of the steerable wheel motors 252, 254, the power of the torque feedback motor 260, etc. In some examples, the conversion circuitry 308 is instantiated by programmable circuitry executing conversion instructions and/or configured to perform operations such as those represented by the flowchart(s) of FIG. 16.

FIG. 4 is a block diagram of an example implementation of the VBC circuitry 302 of FIG. 3 to generate the VBC angle request. The VBC circuitry 302 of FIGS. 3 and 4 may be instantiated (e.g., creating an instance of, bring into being for any length of time, materialize, implement, etc.) by programmable circuitry such as a Central Processor Unit (CPU) executing first instructions. Additionally or alternatively, the VBC circuitry 302 of FIGS. 3 and 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the illustrated example of FIG. 4, the VBC circuitry 302 includes example main incremental angle determination circuitry 402, example derivative incremental angle determination circuitry 404, example return to center incremental angle determination circuitry 406 (R2C incremental angle determination circuitry 406), example damping incremental angle determination circuitry 408, and example VBC angle determination circuitry 410. In some examples, one or more of the main incremental angle determination circuitry 402, the derivative incremental angle determination circuitry 404, the R2C incremental angle determination circuitry 406, the damping incremental angle determination circuitry 408, and/or VBC angle determination circuitry 410 are combined and/or implemented by the steering controller 204 in circuitry distinct from the VBC circuitry 302. The example VBC circuitry 302 of FIGS. 3 and 4 determines multiple incremental angles (e.g., four incremental angles) and adds these incremental angles to the current SWA to generate the final VBC angle request.

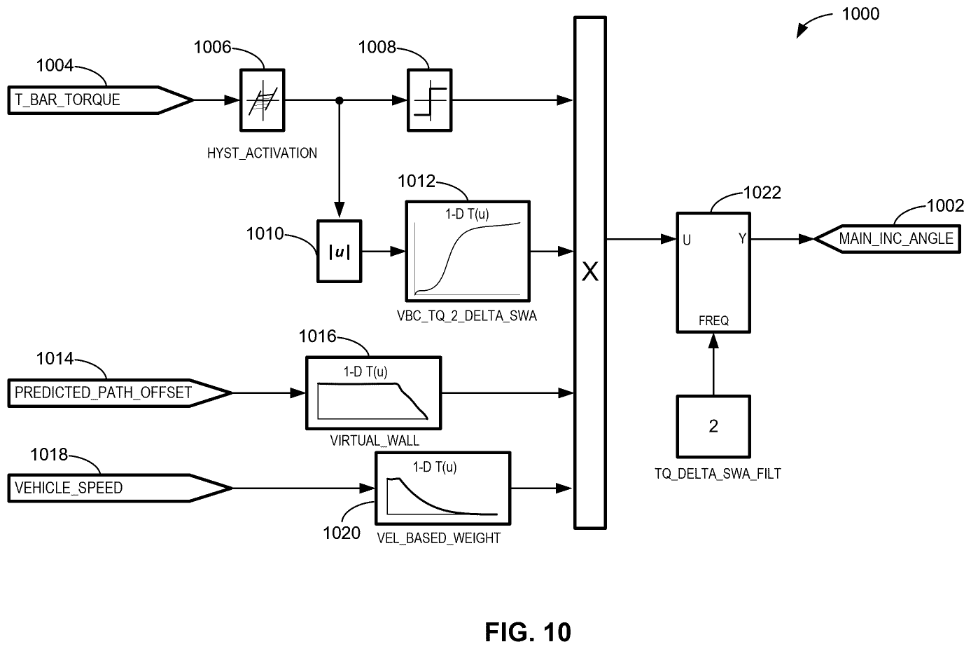

In the illustrated example of FIG. 4, the steering controller 204 includes the main incremental angle determination circuitry 402 to determine a main torque based incremental angle for the VBC angle request. The main incremental angle is used as a base value of the VBC angle request. To determine the main incremental angle, the example main incremental angle determination circuitry 402 passes the input torque through a VBC torque to delta SWA lookup table. For example, the main incremental angle circuitry 402 inputs the torque to the lookup table and outputs a delta SWA. In some examples, the main incremental angle determination circuitry 402 implements a virtual wall lookup table to ensure that driver input cannot cause the vehicle 100 of FIG. 1 to move too far off path. Furthermore, in some examples, the main incremental angle determination circuitry 402 implements a velocity based weight lookup table to reduce the value of the main incremental angle as the speed of the vehicle 100 of FIG. 1 increases. In some examples, the main incremental angle determination circuitry 402 is instantiated by programmable circuitry executing main incremental angle determination instructions and/or configured to perform operations such as those represented by the flowchart(s) of FIG. 17. Further details of the main incremental angle determination circuitry 402 are described below in connection with FIG. 10.

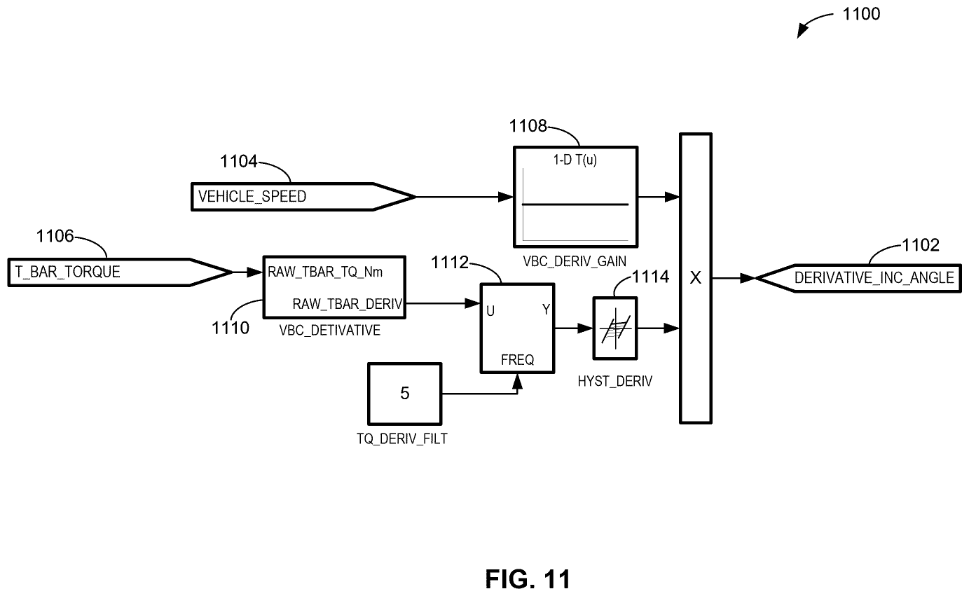

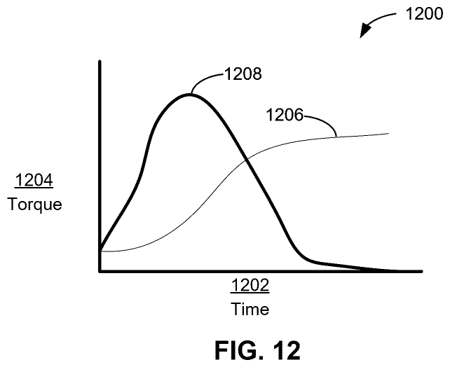

In the illustrated example of FIG. 4, the steering controller 204 includes the derivative incremental angle determination circuitry 404 to determine a torque derivative based incremental angle for the VBC angle request. In some examples, the VBC angle determination circuitry 410 adds the derivative incremental angle to the main incremental angle to provide some lead action in moving the steering wheel 206. In other words, the derivative incremental angle determination circuitry 404 determines the derivative incremental angle to increase a response time of the steering controller 204. Thus, the derivative incremental angle circuitry 404 causes the VBC angle request to have greater influence on angle control of the vehicle 100 over the conditioned PF angle request. Furthermore, the derivative incremental angle determination circuitry 404 limits the gain of the main incremental angle to increase responsiveness and maintain stability of the steering system 200, 250 of FIGS. 2A-2B. In some examples, the derivative incremental angle determination circuitry 404 is instantiated by programmable circuitry executing derivative incremental angle determination instructions and/or configured to perform operations such as those represented by the flowchart(s) of FIG. 17. Further details of the main incremental angle determination circuitry 402 are described below in connection with FIGS. 11 and 12.

In the illustrated example of FIG. 4, the steering controller 204 includes the R2C incremental angle determination circuitry 406 to determine a R2C incremental angle for the VBC angle request. In some examples, to return the steering wheel 206 (FIGS. 2A-2B) back to a reference position (e.g., automated vehicle path), the R2C incremental angle is subtracted from the main incremental angle and the derivative incremental angle to determine the VBC angle request. The example R2C incremental angle determination circuitry 406 generates the R2C incremental angle based on the difference between the current SWA and a R2C reference. As used herein, the R2C reference is a SWA angle that corresponds to the instantaneous path curvature. Thus, the steering wheel 206 is urged toward the R2C reference (e.g., the instantaneous path or the conditioned PF angle request) during self-driving mode. For example, when the driver applies the input torque to the steering wheel 206, the driver feels the resistance that the R2C incremental angle determination circuitry 406 imposes on the steering wheel 206 based on the R2C incremental angle and/or the position of the R2C reference. When driving without automated steering based on angle control, the mechanical components of the steering system 200 (e.g., steerable wheels 218, 220, tires, suspension, etc.) cause the steering wheel 206 to naturally return to a central position. However, because the VBC circuitry 302 is continuously controlling one or more of the motor(s) 214, 252, 254, 260 to steer the vehicle 100, the steering system 200 may not naturally return the vehicle 100 to center while in the self-driving mode. Thus, the R2C incremental angle determination circuitry 406 is implemented in the steering controller 204 to return to the steering wheel 206 and the steerable wheels 218, 220 to the center/neutral position.

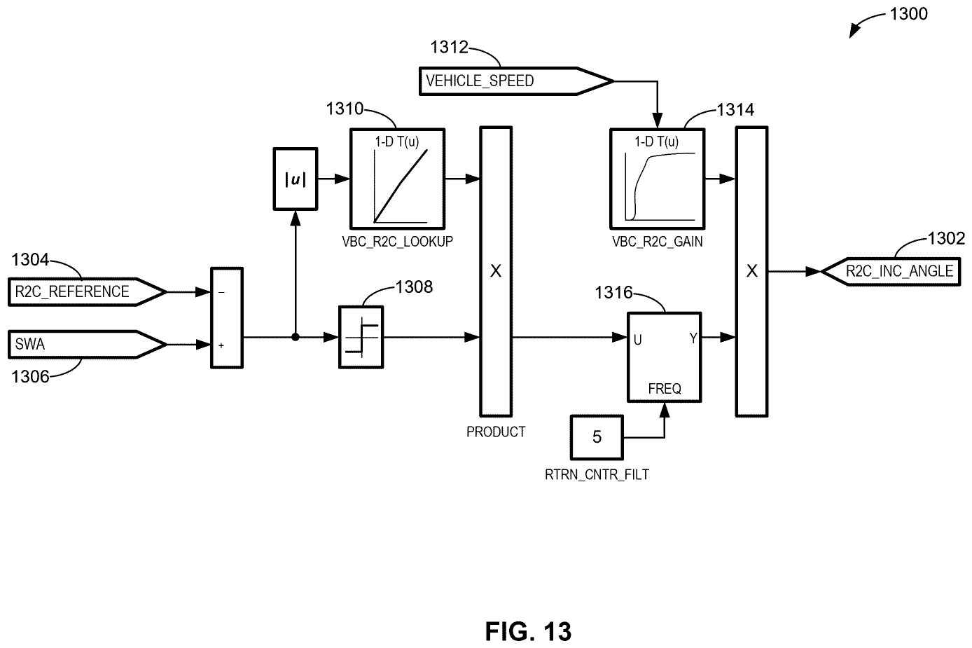

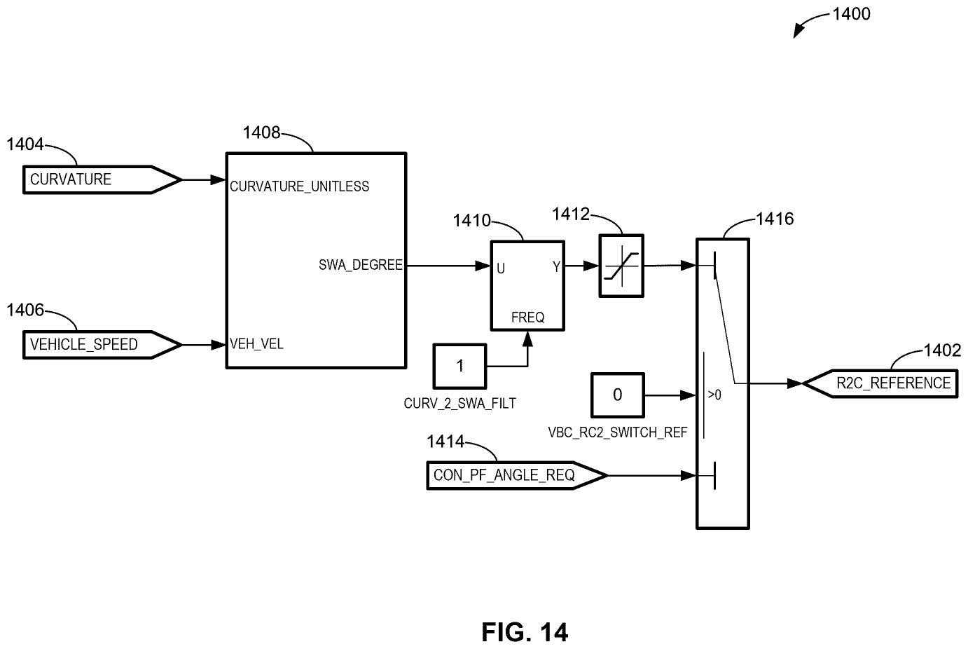

In examples disclosed herein, the R2C reference is used in place of a central position (e.g., zero SWA) of the steering wheel 206 (FIGS. 2A-2B). In some examples, the R2C incremental angle determination circuitry 406 determines the R2 reference based on vehicle speed and an understeer gradient. Additionally or alternatively, the R2C reference corresponds to the conditioned PF angle request. The VBC angle determination circuitry 410 subtracts the R2C incremental angle from the main incremental angle to determine the final VBC angle request. Thus, the R2C incremental angle determination circuitry 406 determines the R2C incremental angle to provide resistance and/or counteraction to the driver input torque. For example, when the driver input torque is removed from the steering wheel 206 (FIGS. 2A-2B), the R2C incremental angle still has a non-zero value and causes the motor 214 (FIG. 2A) or the motors 252, 254, 260 (FIG. 2B) to steer the vehicle 100 (FIG. 1) back on the target path. In some examples, the R2C incremental angle determination circuitry 406 is instantiated by programmable circuitry executing R2C incremental angle determination instructions and/or configured to perform operations such as those represented by the flowchart(s) of FIG. 17. Further details on the R2C incremental angle determination circuitry 406 are described in connection with FIGS. 13 and 14.

In the illustrated example of FIG. 4, the steering controller 204 includes the damping incremental angle determination circuitry 408 to determine a damping incremental angle for the VBC angle request. The damping incremental angle determination circuitry 408 determines the damping incremental angle to provide a natural steering feel to the VBC angle request. As mentioned above in connection with the R2C incremental angle determination circuitry 406, the mechanical components of the steering system 200, 250 (FIGS. 2A-2B) do not provide feedback (e.g., centering movement) to the driver during self-driving mode. Furthermore, the steering system 200 does not mechanically dampen the steering movement to limit uncontrolled movement and/or oscillation of the steering wheel 206. Thus, the damping incremental angle determination circuitry 408 generates the damping incremental angle to provide negative feedback of the steering wheel velocity (e.g., rate of change of SWA). In other words, while the main incremental angle and the derivative incremental angle cause the steering wheel 206 (FIGS. 2A-2B) to turn (e.g., based on input torque), the R2C incremental angle and the damping incremental angle cause the steering wheel 206 to “spring” back to PF control.

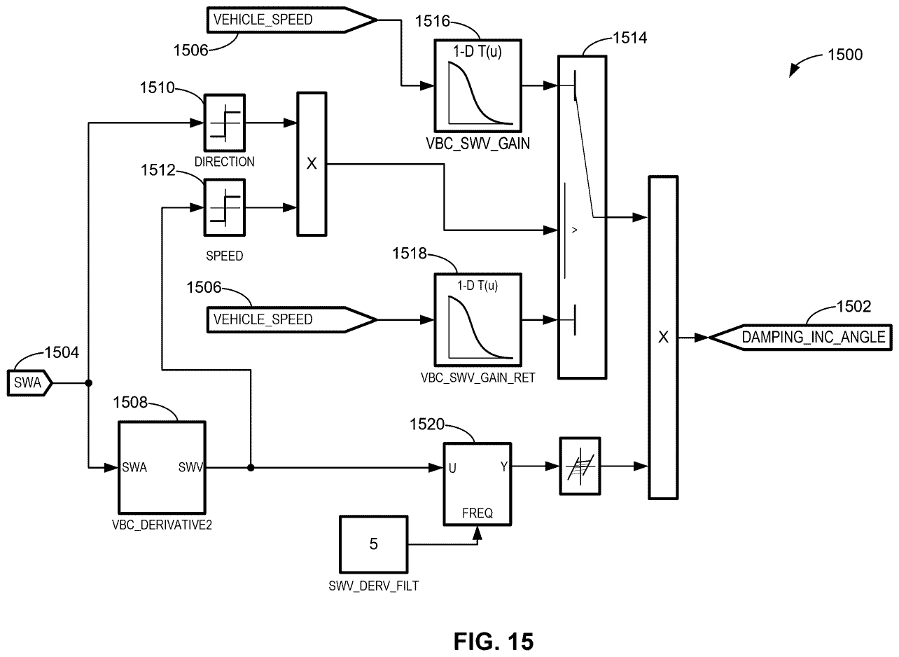

In some examples, the magnitude of the damping incremental angle is based on vehicle speed such that the higher vehicle speeds result in lower damping incremental angles. Furthermore, in some examples, the magnitude of the damping incremental angle is based on the direction of the SWA. For example, the damping incremental angle is lower when the steering wheel 206 is turned away from center at a certain rate relative to the damping incremental angle when the steering wheel 206 turned toward center at the same rate. In some examples, the damping incremental angle determination circuitry 408 is instantiated by programmable circuitry executing damping incremental angle determination instructions and/or configured to perform operations such as those represented by the flowchart(s) of FIG. 17. Further details regarding the damping incremental angle determination circuitry 408 are described in connection with FIG. 15.

In the illustrated example of FIG. 4, the steering controller 204 includes the VBC angle determination circuitry 410 to determine a final VBC angle request. In some examples, the final VBC angle request is determined based on a combination of the four incremental angles, including (1) the main incremental angle, (2) the derivative incremental angle, (3) the R2C incremental angle, and (4) the damping incremental angle, and the current SWA (or instantaneous SWA). In some examples, the VBC angle determination circuitry 410 obtains the incremental angles (e.g., main, derivative, R2C, damping) from the corresponding circuitry and obtains the current SWA from the SWA sensor 224 (FIGS. 2A-2B). In some examples, to determine the combination of the incremental angles, the example VBC angle determination circuitry 410 sums the main incremental angle and the derivative incremental angle and subtracts the R2C incremental angle and the damping incremental angle. Then, the combination of incremental angles is added to the current SWA to generate the final VBC angle request.

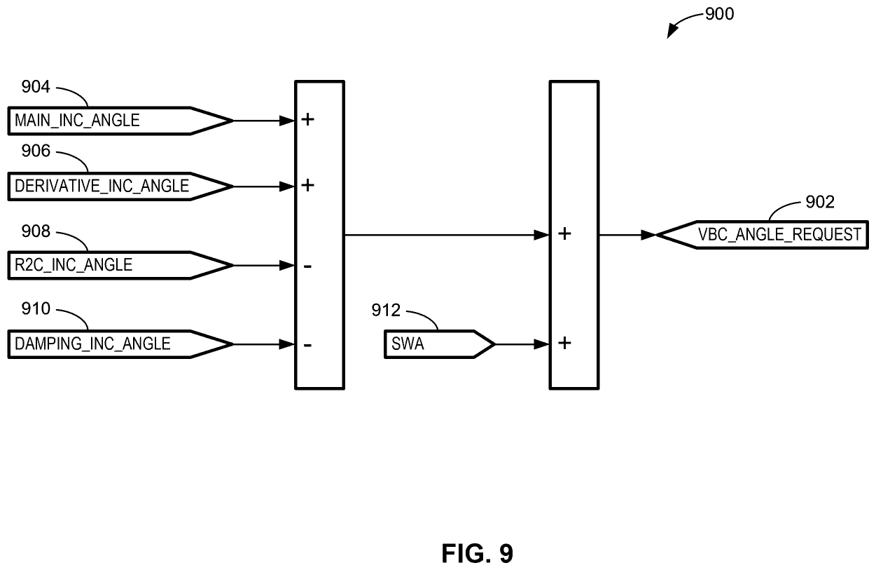

In some examples, in response to the determination of the final VBC angle request, the VBC angle determination circuitry 410 provides the final VBC angle request to the angle blending circuitry 306 to be combined with the conditioned PF angle request and generate the final angle request. Additionally or alternatively, the VBC angle determination circuitry 410 provides the final VBC angle request to one or more of the motor(s) 214, 252, 254, 260 and/or another component of the steering system 200 after the determination of the final VBC angle request. In some examples, the VBC angle determination circuitry 410 is instantiated by programmable circuitry executing final VBC angle determination instructions and/or configured to perform operations such as those represented by the flowchart(s) of FIG. 17. Further details regarding the VBC angle determination circuitry 410 are described in connection with FIG. 9.

FIG. 5 is a block diagram of an example implementation of the angle blending circuitry 306 of FIG. 3 to generate the angle blending weight and to determine the final angle request to be used to generate the torque response of one or more of the motor(s) 214, 252, 254, 260 (FIGS. 2A-2B and 3). The angle blending circuitry 306 of FIGS. 3 and 5 may be instantiated (e.g., creating an instance of, bring into being for any length of time, materialize, implement, etc.) by programmable circuitry such as a Central Processor Unit (CPU) executing first instructions. Additionally or alternatively, the angle blending circuitry 306 of FIGS. 3 and 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the angle blending circuitry 306 includes example angle blending weight determination circuitry 502 and example final angle determination circuitry 504. In some examples, one or more of the angle blending weight determination circuitry 502 and/or the final angle determination circuitry 504 are combined and/or implemented by the steering controller 204 in circuitry distinct from the angle blending circuitry 306. The example angle blending circuitry 306 of FIGS. 3 and 5 determines the angle blending weight based on the driver input torque and the vehicle 100. The example angle blending circuitry 306 applies the angle blending weight to the conditioned PF angle request and the VBC angle request to determine the final angle request. Thus, the angle blending circuitry 306 can adjust the influence of the VBC circuitry 302 and the PF circuitry 304 on the automatic angle control during the self-driving mode. For example, the angle blending circuitry 306 can increase the VBC angle request and decrease the conditioned PF angle request in the final angle request when the vehicle 100 is at lower speeds and vice versa when the vehicle 100 is at higher speeds.

The final angle request sent to the angle controller (e.g., the conversion circuitry 308 and/or one or more of the motor(s) 214, 252, 254, 260 of FIG. 3) is a combination of and/or based on the VBC angle request and the conditioned PF angle request. However, if the driver is not interacting with the steering wheel 206, the final angle request solely includes the conditioned PF angle request. In some examples, the angle blending weight represents an amount of driver interaction with the steering wheel 206 and ranges from 0 to 1, where 1 corresponds to fully engaged driver interaction. In some examples, the angle blending weight determination circuitry 502 is instantiated by programmable circuitry executing angle blending weight determination instructions and/or configured to perform operations such as those represented by the flowchart(s) of FIG. 17. In some examples, the final angle determination circuitry 504 is instantiated by programmable circuitry executing final angle determination instructions and/or configured to perform operations such as those represented by the flowchart(s) of FIG. 17.

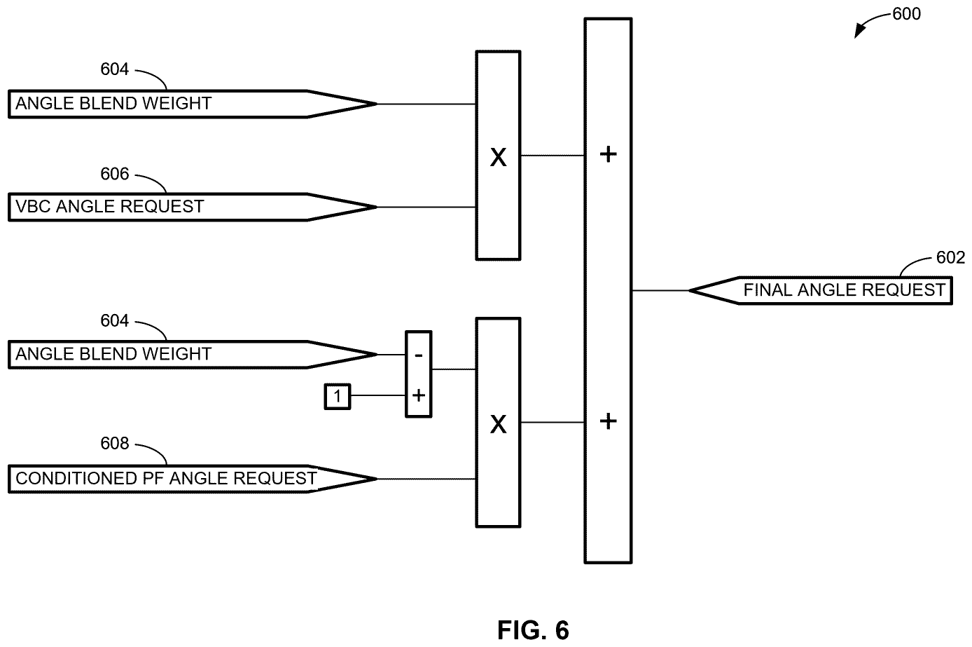

FIG. 6 illustrates an example final angle generation operation 600 that the example final angle determination circuitry 504 of FIG. 5 performs and/or executes to determine an example final angle request 602. As mentioned, the final angle request 602 is converted to a torque request for one or more of the motor(s) 214, 252, 254, 260 (FIGS. 2A-2B and 3) to apply to the steering system 200, 250 (e.g., the gear rack 212, the pinion 210, the steering column 208, the steerable wheels 218, 220, the steering wheel 206, etc.) of the vehicle 100 to achieve the final steering angle.

In the illustrated example of FIG. 6, the final angle determination circuitry 504 computes a product of an angle blending weight 604 and a VBC angle request 606. The example angle final angle determination circuitry 504 also subtracts the angle blending weight 604 from one and multiplies the difference by a conditioned PF angle request 608. As such, the value of the angle blending weight is between zero and one. The example final angle determination circuitry 504 sums the two products to determine the final angle request 602.

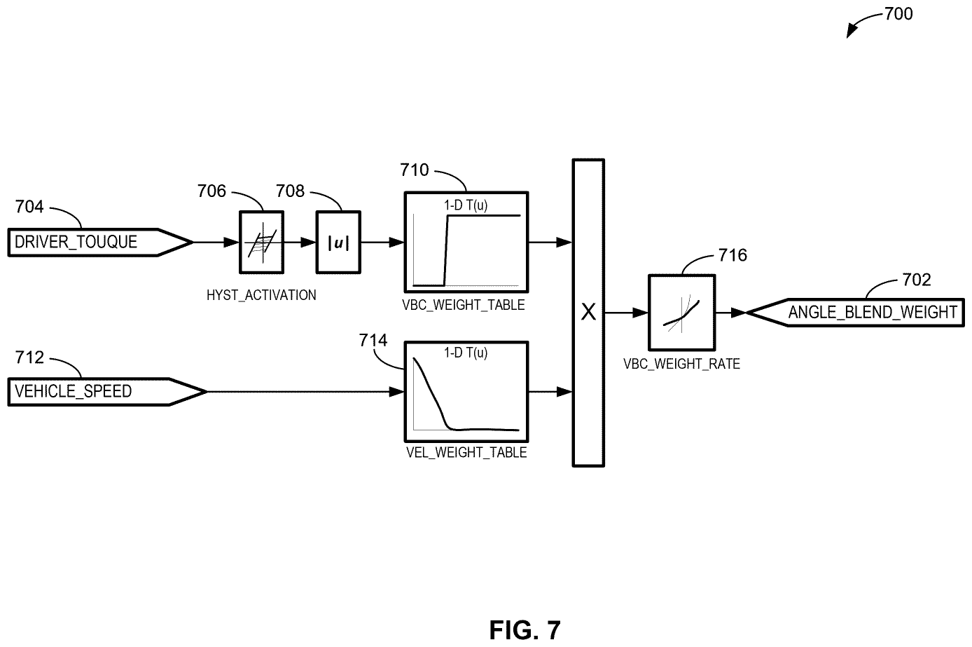

FIG. 7 illustrates an example angle blending weight generation operation 700 that the example angle blending weight determination circuitry 502 of FIG. 5 performs and/or executes to determine an example angle blending weight 702. In some examples, the angle blending weight 702 corresponds to the angle blending weight 604 of FIG. 6. In some examples, the angle blending weight determination circuitry 502 provides the angle blending weight 702 to the final angle determination circuitry 504 (FIG. 5) in response to a request to generate the final angle and/or in response to detected driver input torque via the torque sensor 222 of FIGS. 2A-2B.

In the illustrated example of FIG. 7, the angle blending weight determination circuitry 502 obtains a driver input torque 704 (e.g., from the torque sensor 222) and performs an example hysteresis operation 706 to introduce some lag in the system. For example, the hysteresis operation 706 can delay the generation of the angle blending weight 702 by a certain length of time (e.g., 10 milliseconds (ms), 50 ms, 100 ms, etc.). The example angle blending weight determination circuitry 502 determines an absolute value 708 of the driver torque 704. In some examples, the angle blending weight determination circuitry 502 inputs the absolute value 708 into an example VBC weight lookup table 710 to determine a VBC weight or preliminary weight. In some examples, the angle blending weight determination circuitry 502 determines whether the driver torque 704 satisfies a VBC weight threshold based on the VBC weight lookup table 710. In some examples, when the driver torque 704 satisfies (e.g., exceeds) the VBC weight threshold, the preliminary weight is one. In some examples, when the driver torque 704 satisfies the VBC weight threshold, the preliminary weight is a value less than one. In some examples, the preliminary weight is set to 0.85. However, in other examples the preliminary weight can be set to a higher or lower value.

In the illustrated example of FIG. 7, the angle blending weight determination circuitry 502 obtains a vehicle speed 712 that corresponds to a current or instantaneous speed of the vehicle 100 (FIG. 1). In some examples, the vehicle speed 712 is measured and/or detected using a vehicle speed sensor (VSS) that measures transmission/transaxle output or wheel speed. The angle blending weight determination circuitry 502 inputs the vehicle speed 712 into an example velocity based weight lookup table 714 to determine a velocity based weight. In some examples, the velocity based weight ranges between a maximum value and a minimum value, which may be between 0 and 1. For example, in some instances, the maximum value is 0.95 and the minimum value is 0.85. Therefore, as the vehicle speed 712 increases, the velocity based weight gradually reduces from 0.95 to 0.85. In some examples, when the vehicle speed 712 satisfies a vehicle speed threshold (e.g., 45 mph, 60 mph, etc.), the velocity based weight is set to the minimum (e.g., 0.85). In other examples, other range values can be used.

In the illustrated example of FIG. 7, the angle blending weight determination circuitry 502 multiplies the VBC weight and the velocity based weight to determine the angle blending weight 702. The example angle blending weight determination circuitry 502 also implements an example rate limiter 716 to limit and/or control the rate of angle blending weight values are provided to the final angle determination circuitry 504.

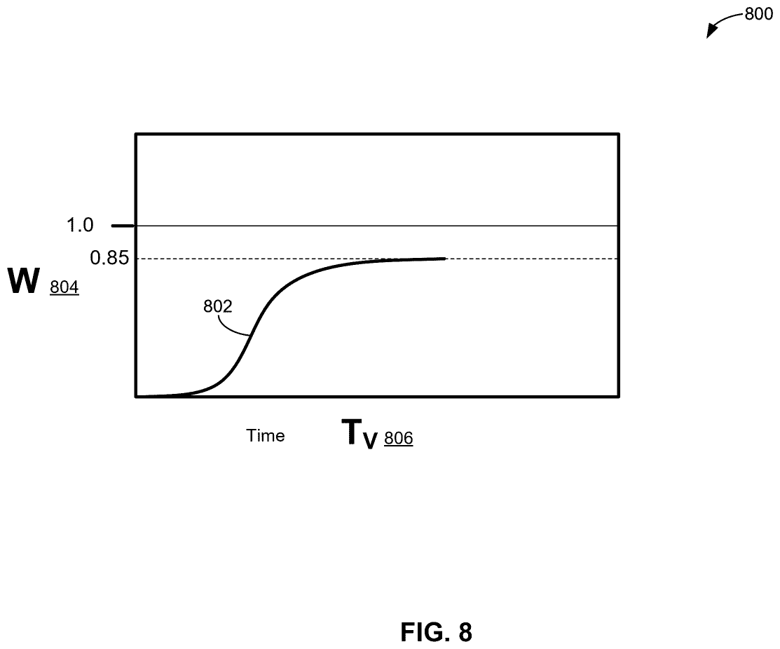

FIG. 8 is an example chart 800 that represents example values of an angle blending weight 802 based on the operations 700 of FIG. 7. In the example chart 800, the y-axis 804 corresponds to the angle blending weight and the x-axis 806 corresponds to the driver input torque. As shown in the example chart 800, as the driver input increases along the x-axis 806, the angle blending weight increases along the y-axis 840. Furthermore, the angle blending weight 802 asymptotically approaches an example weight limit value of 0.85 as the driver torque increases for a given vehicle speed. Thus, because the angle blending weight 802 does not reach a value of one, the final angle request cannot be solely comprised of the VBC angle. In some examples, the weight limit value of the angle blending weight 802 is another value other than 0.85 (e.g., 0.75, 0.90, 0.99, etc.).

FIG. 9 is an example VBC angle request generation operation 900 that the VBC angle determination circuitry 410 performs to determine a VBC angle request 902. In some examples, the VBC angle determination circuitry 410 provides the VBC angle request to the angle blending circuitry 306 (e.g., the final angle determination circuitry 504 of FIG. 5) in response to determining the VBC angle request. The example VBC angle determination circuitry 410 obtains an example main incremental angle 904, an example derivative incremental angle 906, an example R2C incremental angle 908, and an example damping incremental angle 910 from corresponding components of the example VBC circuitry 302 of FIGS. 3 and 4. Furthermore, the example VBC angle determination circuitry 410 obtains an example current SWA or instantaneous SWA from the SWA sensor 224 of FIGS. 2A-2B.

In the illustrated example of FIG. 9, the VBC angle determination circuitry 410 determines a combination of the incremental angles 904-910. More specifically, the example VBC angle determination circuitry 410 sums the main incremental angle 904 and the derivative incremental angle 906 and subtracts the R2C incremental angle 908 and the damping incremental angle 910. The example VBC angle determination circuitry 410 adds the combination of the incremental angles 904-910 to the current SWA 912 to determine the VBC angle request 902.

FIG. 10 illustrates an example main incremental angle generation operation 1000 that the main incremental angle determination circuitry 402 performs to determine an example main incremental angle 1002. In some examples, the main incremental angle determination circuitry 402 provides the main incremental angle 1002 to the VBC angle determination circuitry 410 in response to a request from the VBC angle determination circuitry 410. The example main incremental angle 1002 can correspond to the main incremental angle 904 of FIG. 9.

In the illustrated example of FIG. 10, the main incremental angle determination circuitry 402 obtains an example input torque 1004 from the torque sensor 222 of FIGS. 2A-2B. In some examples, the main incremental angle determination circuitry 402 performs an example hysteresis activation function 1006 on the input torque 1004 to provide some delay in the main incremental angle generation operation 1000. The example incremental angle determination circuitry 402 passes the torque through a sign determiner 1008 to output the sign of the input torque 1004. For example, when the main incremental determination circuitry 402 determines that the driver turned the steering wheel 206 to the right when applying the input work 1004, the sign determiner 1008 outputs a +1. In parallel, the example main incremental angle determination circuitry 402 performs an absolute value function 1010 on the input torque 1004 and inputs the absolute value of the input torque to an example VBC torque to delta SWA lookup table 1012. In some examples, the main incremental angle determination circuitry 402 implements the VBC torque to delta SWA lookup table 1012 to determine delta SWA based on the torque input 1004. In some examples, a different lookup table is used based on the type of vehicle, mechanical components of the steering system 200, etc.

In the illustrated example of FIG. 10, the main incremental angle determination circuitry 402 obtains an example predicted path offset 1014 from the PF circuitry 304 of FIG. 3. In some examples, the predicted path offset 1014 is the difference between the current SWA and the conditioned PF angle request generated by the PF circuitry 304 and the PF conditioning circuitry 305. In some examples, the particular path offset is a lateral distance between a current path of the vehicle 100 of FIG. 1 and a target path determined by the PF circuitry 304. The example main incremental angle determination circuitry 402 inputs the predictive path offset 1014 to an example virtual wall lookup table 1016 to determine a virtual wall weight. In some examples, when the predicted path offset 1014 satisfies a virtual wall threshold, the virtual wall weight gradually and or immediately reduces to 0. Thus, when the vehicle 100 moves too far off of the target path (e.g., the predicted path offset 1014 satisfies the virtual wall threshold), the virtual wall weight and the main incremental angle 1002 reduces to 0.

In the illustrated example of FIG. 10, the main incremental angle determination circuitry 402 obtains an example vehicle speed 1018, which can correspond to the example vehicle speed 712 of FIG. 7. The example main incremental angle determination circuitry inputs the vehicle speed 1018 into an example velocity based weight lookup table 1020 to determine a velocity based weight. Similar to the velocity based weight lookup table 714 of FIG. 7, the output of the lookup table 1020 reduces as the vehicle speed 1018 increases. However, the output of the velocity based weight lookup table 1020 reduces at a different rate (e.g., quadratic rate, etc.) than the velocity based lookup table 714 of FIG. 7.

In the illustrated example of FIG. 10, the main incremental angle determination circuitry 402 multiplies the sign of the input torque 1004, the delta WA output from the lookup table 1012, the virtual wall weight output from the lookup table 1016, and the velocity based weight output from the lookup table 1020 to determine a product corresponding to a preliminary main incremental angle. The example main incremental angle determination circuitry 402 inputs the preliminary main incremental angle into an example low pass filter 1022 to limit the frequency of the main incremental angle 1002. For example, the low pass filter 1022 can set a maximum limit of the main incremental angle 1002 such that the VBC angle request is not substantially high. In the illustrated example of FIG. 10, the low pass filter 1022 implements a limit of two Hertz (Hz). However, the example low pass filter 1022 can implement another frequency based on an average value of the VBC angle request.

FIG. 11 illustrates an example derivative incremental angle generation operation 1100 that the derivative incremental angle determination circuitry 404 performs to determine an example derivative incremental angle 1102. In some examples, the derivative incremental angle determination circuitry 404 provides the derivative incremental angle 1102 to the VBC angle determination circuitry 410 in response to a request from the VBC angle determination circuitry 410. The example derivative incremental angle 1102 can correspond to the derivative incremental angle 906 of FIG. 9.

In the illustrated example of FIG. 11, the derivative incremental angle determination circuitry 404 obtains an example vehicle speed 1104 from an example vehicle speed sensor and an example input torque 1106 from the example torque sensor 222 of FIGS. 2A-2B. The derivative incremental angle determination circuitry 404 inputs the vehicle speed 1104 into a VBC derivative gain function 1108 to determine an example gain value to be applied to a preliminary derivative incremental angle.

To determine the preliminary derivative incremental angle, the derivative incremental angle determination circuitry 404 inputs the input torque 1106 into a VBC derivative function 1110. In some examples the VBC derivative function 1110 inputs the input torque 1106 and outputs a torque derivative. In some examples the VBC derivative function 1110 also includes a lookup table to output a virtual SWA based on the torque input 1106. The example derivative incremental angle determination circuitry 404 then adds the torque derivative to the virtual SWA to determine the preliminary derivative incremental angle. In some examples, the derivative incremental angle determination circuitry 404 inputs the preliminary derivative incremental angle into an example low pass filter 1112 to limit the frequency of the derivative incremental angle. Furthermore, the derivative incremental angle determination circuitry 404 inputs the filtered preliminary derivative incremental angle into an example hysteresis function 1114 to apply a delay to the example operation 1100. In some examples, the product of the gain value and the preliminary derivative incremental angle corresponds to the derivative incremental angle 1102.

FIG. 12 is an example first derivative incremental angle chart 1200 representative of the example derivative incremental angle generation operation 1100 of FIG. 11. In the illustrated examples of FIG. 12, the x-axis 1202 corresponds to time and the y-axis 1204 corresponds to torque. In the chart 1200, a first curve 1206 represents torque input, and a second curve 1208 represents the derivative of the first curve 1206.

FIG. 13 illustrates an example R2C incremental angle generation operation 1300 that the R2C incremental angle determination circuitry 406 performs to determine an example R2C incremental angle 1302. In some examples, the R2C incremental angle determination circuitry 406 provides the R2C incremental angle 1302 to the VBC angle determination circuitry 410 in response to a request from the VBC angle determination circuitry 410. The example R2C incremental angle 1302 can correspond to the R2C incremental angle 908 of FIG. 9.

In the illustrated example of FIG. 13, the R2C incremental angle determination circuitry 406 obtains an example R2C reference 1304 and an example current SWA 1306. In some examples, the R2C incremental angle determination circuitry 406 generates the R2C reference 1304. In some examples the R2C incremental angle determination circuitry 406 obtains the R2C reference 1304 from other circuitry hardware (e.g., the PF circuitry 304, the VBC circuitry 302, etc.). The example R2C incremental angle determination circuitry 406 subtracts the R2C reference 1304 from the current SWA 1306 to determinate a preliminary R2C incremental angle. In some examples the R2C incremental angle determination circuitry 406 implements a sign determiner 1308 to output a value of positive one or a negative one based on the R2C reference 1304 relative to the current SWA 1306. For example, the sign determiner 1308 outputs a value of negative one if the current SWA 1306 is to the left of the R2C reference 1304, and vice versa.

In the illustrated example of FIG. 13, the R2C incremental angle determination circuitry 406 inputs the absolute value of the difference between the current SWA 1306 and the R2C reference 1304 into an example VBC to R2C lookup table 1310. The example R2C incremental angle determination circuitry 406 multiplies the output of the lookup table 1310 by the output of the sign determiner 1308 to determine a preliminary R2C incremental angle. Furthermore, the example R2C incremental angle determinations circuitry 406 obtains an example vehicle speed 1312. In some examples, the R2C incremental angle determination circuitry 406 inputs the vehicle speed 1312 into an example VBC R2C gain lookup table 1314 to determine a gain factor. In some examples, the R2C incremental angle determination circuitry 406 passes the preliminary R2C incremental angle through an example low pass filter 1316. The example R2C incremental angle determination circuitry 406 then multiplies the filtered preliminary R2C incremental angle by the gain factor to determine the R2C incremental angle 1302.

FIG. 14 is an example R2C reference generation operation 1400 that the R2C incremental angle determination circuitry 406 performs to determine an example R2C reference 1402. In some examples, the R2C reference 1402 corresponds to the R2C reference 1304 of FIG. 13. In the illustrated example of FIG. 14, the R2C incremental angle determination circuitry 406 obtains an example curvature 1404 of the current vehicle path from the example PF circuitry 304 of FIG. 3. Furthermore, the example R2C incremental angle determination circuitry 406 obtains an example vehicle speed 1406 from another sensor of the vehicle 100, such as a vehicle speed sensor. In the illustrated example of FIG. 14, the R2C incremental angle determination circuitry 406 inputs the curvature 1404 and the vehicle speed 1406 into an example SWA determination function 1408.

In some examples, the R2C incremental angle determination circuitry 406 implements the SWA determination function 1408 determine a preliminary R2C reference based on the curvature 1404 and the vehicle speed 1406. The preliminary R2C reference is passed through an example low pass filter 1410 and an example rate limiter 1412. The example R2C incremental angle determination circuitry 406 can also obtain an example conditioned PF angle request 1414 from the PF conditioning circuitry 305 of FIG. 3. In some examples, the R2C incremental angle determination circuitry 406 implements a switching operation 1416 to switch between the preliminary R2C reference and the conditioned PF angle request 1414. In some examples, the switching operation 1416 is used to switch between the preliminary R2C reference and the conditioned PF angle request 1414 based on whether an error between the preliminary R2C reference and the conditioned PF angle request 1414 exceeds a threshold error. For example, when the difference between the preliminary R2C and the conditioned PF angle request 1414 is greater than zero, the switching operation 1416 switches to the preliminary R2C reference. Otherwise, the switching operation 1416 switches to the conditioned PF angle request 1414.

FIG. 15 is an example damping incremental angle generation operation 1500 that the damping incremental angle determination circuitry 408 performs to determine an example damping incremental angle 1502. In some examples, the damping incremental angle 1502 corresponds to the damping incremental angle 910 of FIG. 9. In the illustrated example of FIG. 15, the damping incremental angle determination circuitry 408 obtains an example current SWA 1504 from the example SWA sensor 224 of FIGS. 2A-2B. Furthermore, the example damping incremental angle determination circuitry 408 obtains an example vehicle speed 1506 from another sensor of the vehicle 100, such as a vehicle speed sensor.

In the illustrated example of FIG. 15, the damping incremental angle determination circuitry 408 inputs the current SWA 1504 into an example VBC derivative function 1508 to determine a steering wheel velocity (SWV). In some examples, the damping incremental angle determination circuitry 408 obtains multiple SWA measurements over a period of time to determine the SWV. The example damping incremental angle determination circuitry 408 inputs the SWA 1504 into a first sign determination function 1510 and inputs the SWV into a second sign determination function 1512. The damping incremental angle determination circuitry 408 uses the first sign determination function 1510 to output a positive one or a negative one based on the position of the SWA 1504 relative to the R2C reference. For example, when the steering wheel 206 (FIGS. 2A-2B) is turned to the right of the R2C reference, the first sign determination function 1510 outputs a positive one. Alternatively, when the steering wheel 206 (FIGS. 2A-2B) is turned to the left of the R2C reference, the first sign determination function 1510 outputs a negative one. Furthermore, the damping incremental angle determination circuitry 408 uses the second sign determination function 1512 to output a positive one or a negative one based on the direction of the SWV relative to the R2C reference. For example, when the steering wheel 206 (FIGS. 2A-2B) is being turned to the right, the first sign determination function 1510 outputs a positive one. Alternatively, when the steering wheel 206 (FIGS. 2A-2B) is being turned to the left, the first sign determination function 1510 outputs a negative one. The example damping incremental angle determination circuitry 408 determines a product of the two outputs to obtain a positive or negative one based on how the steering wheel 206 is being turned relative to the R2C reference. Thus, when the steering wheel 206 is moving toward the R2C reference, the product is a negative one. Alternatively, when the steering wheel 206 is moving away from the R2C reference, the product is a positive one.

In the illustrated example of FIG. 15, the damping incremental angle determination circuitry 408 implements a switching function 1514 to switch between an SWV departure gain lookup table 1516 and an SWV return gain lookup table 1518. When the example damping incremental angle determination circuitry 408 determines the steering wheel 206 is being turned away from center (e.g., product of 1510 and 1512 is positive one), the switching function 1514 causes the damping incremental angle determination circuitry 408 to use the SWV departure gain lookup table 1516. Alternatively, when the example damping incremental angle determination circuitry 408 determines the steering wheel 206 is being turned toward center (e.g., product of 1510 and 1512 is negative one), the switching function 1514 causes the damping incremental angle determination circuitry 408 to use the SWV return gain lookup table 1518. In some examples, the model and/or properties of the SWV departure gain lookup table 1516 and the SWV return gain lookup table 1518 are different. For example, the gain output of the SWV return gain lookup table 1518 for a given value of the vehicle speed 1506 is greater than the gain output of the SWV departure gain lookup table 1516. In some examples, the gain output from the SWV departure gain lookup table 1516 or the SWV return gain lookup table 1518 is a unitless value or coefficient.

In the illustrated example of FIG. 15, the damping incremental angle determination circuitry 408 implements a low pass filter 1520 to limit and/or control a frequency of computations of the damping incremental angle 1502. The outputs of the switching function 1514 and the low pass filter 1520 are multiplied. In some examples, the damping incremental angle determination circuitry 408 also multiplies the product by the time period over which the SWA 1504 was measured to determine the damping incremental angle 1502.

FIG. 16 is a block diagram of an example implementation of the PF conditioning circuitry 305 to generate the conditioned PF angle to be considered by the angle blending circuitry 306 in the determination of the final angle request. The PF conditioning circuitry 305 of FIG. 16 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the PF conditioning circuitry 305 of FIG. 16 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 16 may, thus, be instantiated at the same or different times. Some or all of the circuitry of FIG. 16 may be instantiated, for example, in one or more threads executing concurrently on hardware and/or in series on hardware. Moreover, in some examples, some or all of the circuitry of FIG. 16 may be implemented by microprocessor circuitry executing instructions and/or FPGA circuitry performing operations to implement one or more virtual machines and/or containers.

The PF conditioning circuitry 305 includes torque filtering circuitry 1602, direction dismissing circuitry 1604, noise filtering circuitry 1606, addition circuitry 1608, integration circuitry 1610, leakage circuitry 1612, and conditioned PF angle calculation circuitry 1614.

The PF conditioning circuitry 305 includes the torque filtering circuitry 1602 to filter a torque input by a driver of the vehicle 100 measured by the torque sensor 222. Specifically, the torque filtering circuitry 1602 bandpass filters the torque (e.g., a raw t-bar torque) measured by the torque sensor 222. As discussed above, the torque sensor 222 converts an input torque from the driver of the vehicle 100 to a frequency-based signal (e.g., a frequency output). The torque filtering circuitry 1602 compares the frequency output to a first frequency threshold and a second frequency threshold. When the frequency output is between the first frequency threshold and the second frequency threshold, the torque filtering circuitry 1602 communicates the frequency output to direction dismissing circuitry 1604. More particularly, the first frequency threshold corresponds to a start band frequency of the bandpass filter, and the second frequency threshold corresponds to an end band frequency of the bandpass filter. The first frequency threshold and the second frequency threshold identifies frequency components of the output from the torque sensor 222 that correspond to a dynamic driver input. The first frequency threshold is configured to be a frequency (e.g., 0.5 Hertz (Hz), 0.3 Hz, etc.) that rejects static torque biases encountered at the steering wheel 206 (FIGS. 2A-2B). The second frequency threshold is configured to be a frequency (e.g., 2 Hz, 2.5 Hz, etc.) that rejects high frequency noise while enabling passage of dynamic driver inputs. In some examples, the torque filtering circuitry 1602 configures a start band frequency and a width, and, in turn, an end band frequency of the bandpass filter that the PF conditioning circuitry 305 applies to the torque input. Additionally or alternatively, the steering controller 204 and/or another component of the ECU 202 can configure the start band frequency and the width of the bandpass filter. In some examples, the torque filtering circuitry 1602 is instantiated by programmable circuitry executing torque filtering instructions and/or configured to perform operations such as those represented by the flowchart(s) of FIGS. 18 and/or 19.

The PF conditioning circuitry 305 includes the direction dismissing circuitry 1604 to cause input torques in either direction (e.g., clockwise or counterclockwise) to be represented as the same. Specifically, the direction dismissing circuitry 1604 identifies an absolute value of the filtered torque input to cause torque inputs of the same magnitude in either direction to be represented as the same. In some examples, the direction dismissing circuitry 1604 is instantiated by programmable circuitry executing direction dismissing instructions and/or configured to perform operations such as those represented by the flowchart(s) of FIGS. 18 and/or 19.

The PF conditioning circuitry 305 includes the noise filtering circuitry 1606 to remove signal noise from the filtered torque input. For example, the noise filtering circuitry 1606 can remove torque amplitude in the filtered torque input that are below a threshold (e.g., 0.1). In some examples, the noise filtering circuitry 1606 is instantiated by programmable circuitry executing noise filtering instructions and/or configured to perform operations such as those represented by the flowchart(s) of FIGS. 18 and/or 19.

The PF conditioning circuitry 305 includes the addition circuitry 1608 to combine the filtered torque input signal from the noise filtering circuitry 1606 with a gain from the leakage circuitry 1612. More particularly, the gain can be negative (e.g., a leakage), as discussed further below in connection with the leakage circuitry 1612, such that the value provided to the integration circuitry 1610 causes the output of the integration circuitry 1610 to be attenuated over time to enable dynamic and static torque inputs to be treated differently. Specifically, enabling the instantaneous SWA have a greater effect in response to dynamic torque inputs provides the driver with a desirable control. However, enabling the PF angle request to have a greater effect in response to static torque inputs provides the driver with a torque pushback (e.g., resistance) for static maneuvers, such as steady state biasing in a driving lane. For example, when a static torque input from the driver causes the vehicle 100 to be uncentered within the driving lane, the PF conditioning circuitry 305 can provide a torque feedback at the steering wheel 206 that aligns with shifting the vehicle 100 to a center of the driving lane. Further, when a dynamic torque input from the driver causes the vehicle 100 to slalom, the PF conditioning circuitry 305 modifies the final angle request to prevent such torque pushback from being provided to the driver as the torque pushback is undesirable in such scenarios. The addition circuitry 1608 outputs a conditioned torque input (e.g., the filtered torque input with the leakage applied) to the integration circuitry 1610. In some examples, the addition circuitry 1608 is instantiated by programmable circuitry executing addition instructions and/or configured to perform operations such as those represented by the flowchart(s) of FIGS. 18 and/or 19.

The PF conditioning circuitry 305 includes the integration circuitry 1610 to integrate the conditioned torque input provided by the addition circuitry 1608. Accordingly, the integration circuitry 1610 determines an accumulated torque from the driver over time based on the output from the addition circuitry 1608. Further, the integration circuitry 1610 converts the accumulated torque to a weight between zero and one. For example, the integration circuitry 1610 can convert the accumulated torque to the weight based on a lookup table. The integration circuitry 1610 outputs the weight to the conditioned PF angle calculation circuitry 1614. In some examples, the integration circuitry 1610 is instantiated by programmable circuitry executing integration instructions and/or configured to perform operations such as those represented by the flowchart(s) of FIGS. 18 and/or 19.

The PF conditioning circuitry 305 includes the leakage circuitry 1612 to determine the gain (e.g., the leakage) to be applied to the filtered torque input at the addition circuitry 1608. In some examples, the leakage circuitry 1612 determines the gain based on an output from the integration circuitry 1610. For example, the leakage circuitry 1612 can utilize a lookup table or function that maps the output from the integration circuitry 1610 to the gain. In graphical form, the function used by the leakage circuitry 1612 may have an output from the integrator on an x-axis, and the corresponding gain can be on the y-axis. In some examples, the leakage circuitry 1612 causes the addition circuitry 1608 to apply a constant leakage. Alternatively, the leakage circuitry 1612 can utilize another configuration to cause the addition circuitry 1608 to provide a negative feedback to the integration circuitry 1610. In some examples, the leakage circuitry 1612 is instantiated by programmable circuitry executing instructions and/or configured to perform operations such as those represented by the flowchart(s) of FIGS. 18 and/or 19.

The PF conditioning circuitry 305 includes the conditioned PF angle calculation circuitry 1614 to determine the conditioned PF angle request. For example, the PF angle calculation circuitry 1614 can calculate the conditioned PF angle request based on the weight from the integration circuitry 1610, the PF angle from the PF circuitry 304, and the SWA from the SWA sensor 224. In some examples, the PF angle calculation circuitry 1614 utilizes Equation 1 below to calculate the conditioned PF angle request.

PFconditioned=α*SWA+(1−α)*PFangle Equation 1:

In Equation 1, PFconditioned is the conditioned PF angle request, α is the weight determined by the integration circuitry 1610, SWA is the steering wheel angle measured by the SWA sensor 224, and PFangle is the PF angle request determined by the PF circuitry 304. Thus, the SWA has a first effect (α) on the conditioned PF angle, and the PF angle request has a second effect (1−α) on the conditioned PF angle. Accordingly, when the weight is zero, the conditioned PF angle corresponds to (e.g., is equivalent to) the PF angle request. When the weight is one, the conditioned PF angle request corresponds to (e.g., is equivalent to) the instantaneous SWA. When the torque input is indicative of a dynamic maneuver being performed by the driver, the PF conditioning circuitry 305 increases the weight (e.g., towards a value of 1) to reduce the second effect that the PF angle request has on the conditioned PF angle and increase the first effect that the SWA has on the conditioned PF angle. Further, when the torque input is indicative of a static maneuver being performed by the driver, the PF conditioning circuitry 305 reduces the weight (e.g., towards a value of 0) to increase the second effect that the PF angle request has on the conditioned PF angle and reduce the first effect that the SWA has on the conditioned PF angle. The conditioned PF angle calculation circuitry 1614 can output the conditioned PF angle request to the angle blending circuitry 306 for consideration in the determination of the final angle request to be communicated to one or more of the motor(s) 214, 252, 254, 260. In some examples, the conditioned PF angle calculation circuitry 1614 is instantiated by programmable circuitry executing instructions and/or configured to perform operations such as those represented by the flowchart(s) of FIGS. 18 and/or 19.

FIG. 17 illustrates an example path follower angle request conditioning operation 1700. Accordingly, FIG. 17 shows example implementations of the torque filtering circuitry 1602, the direction dismissing circuitry 1604, the noise filtering circuitry 1606, the addition circuitry 1608, the integration circuitry 1610, the leakage circuitry 1612, and the conditioned PF angle calculation circuitry 1614. In the illustrated example of FIG. 17, the torque filtering circuitry 1602 obtains a t-bar torque 1702 from the torque sensor 222. The t-bar torque 1702 is inputted into a first low-pass filter 1704. In this example, the first low-pass filter 1704 is configured with a first torque threshold of 0.5 Hz. The output of the first low-pass filter is provided to an add block 1706 that subtracts the output of the first low-pass filter from the t-bar torque 1702, thereby forming a high-pass filter. Further, the output of the add block 1706 is provided to a second low-pass filter 1708. In this example, the second low-pass filter is configured with a second torque threshold of 2.5 Hz.

In the illustrated example of FIG. 17, the noise filtering circuitry 1606 passes an absolute value of the output from the second low-pass filter 1708 to the noise filtering circuitry 1606. The noise filtering circuitry 1606 includes a gate 1710 that configures amplitudes (e.g., filtered torque amplitudes) less than a threshold to zero, while allowing amplitudes greater than or equal to the threshold to pass to the addition circuitry 1608. In this example, the threshold is configured as 0.1.

In the illustrated example of FIG. 17, the addition circuitry 1608 subtracts a leakage from the leakage circuitry 1612 from the output of the noise filtering circuitry 1606. In this example, the leakage is a constant magnitude of 0.8 Hz. However, the leakage can be determined in another manner, as discussed above in connection with FIG. 16. The integration circuitry 1610 integrates the output of the addition circuitry 1608. Further, the integration circuitry 1610 converts the integrated output to a weight between zero and one. In the illustrated example of FIG. 17, the conditioned PF angle calculation circuitry 1614 calculates a conditioned PF angle request 1714 based on a SWA 1712, a PF angle request 1714, and the weight. In turn, the PF conditioning circuitry 305 communicates the conditioned PF angle request 1714 to the angle blending circuitry 306 (FIG. 3).

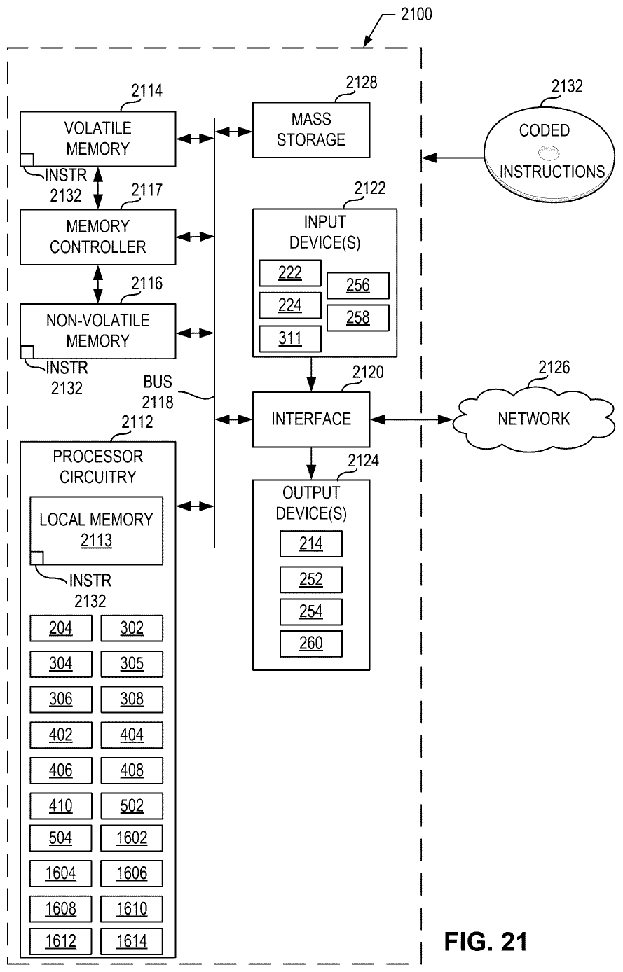

In some examples, the ECU 202 includes means for generating a conditioned path follower angle (PFA) request. For example, the means for generating the conditioned PFA request may be implemented by the PF conditioning circuitry 305. In some examples, the PF conditioning circuitry 305 may be instantiated by programmable circuitry such as the example programmable circuitry 2112 of FIG. 21. For instance, the PF conditioning circuitry 305 may be instantiated by executing machine executable instructions such as those implemented by at least blocks 1804, 1902, 1904, 1906, 1908, 1910, 1912, 1914 of FIGS. 18-19. Additionally or alternatively, the PF conditioning circuitry 305 may be instantiated by any other combination of hardware, software, and/or firmware. For example, the PF conditioning circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the steering controller 204 includes means for generating a virtual boost curve (VBC) angle request. For example, the means for generating the VBC angle request may be implemented by VBC circuitry 302. In some examples, the VBC circuitry 302 may be instantiated by programmable circuitry such as the example programmable circuitry 2112 of FIG. 21. For instance, the VBC circuitry 302 may be instantiated by executing machine executable instructions such as those implemented by at least blocks 1806 and 1808 of FIG. 18. Additionally or alternatively, the VBC circuitry 302 may be instantiated by any other combination of hardware, software, and/or firmware. For example, the VBC circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

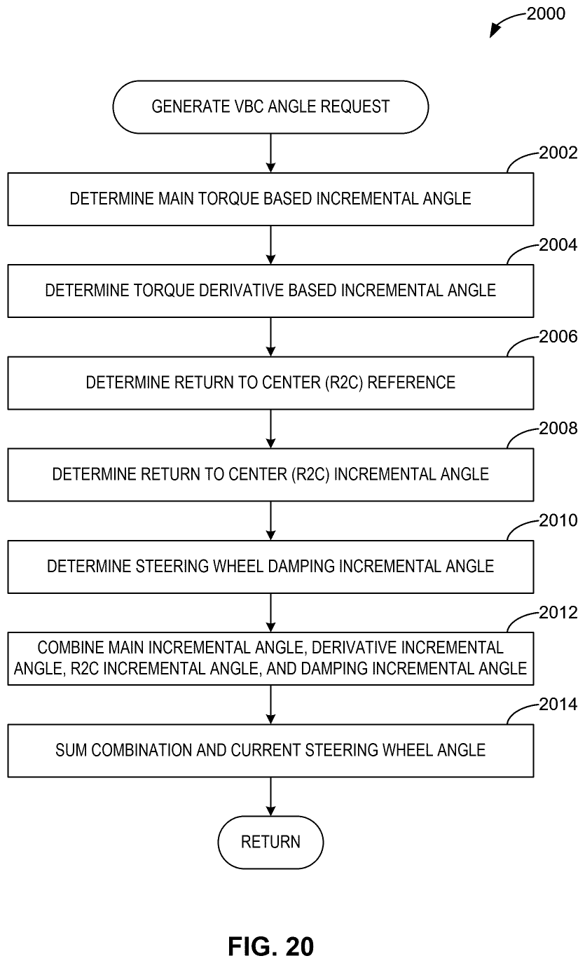

In some examples, the means for generating the VBC angle request includes means for determining a main incremental angle. For example, the means for determining the main incremental angle may be implemented by main incremental angle determination circuitry 402. In some examples, the main incremental angle determination circuitry 402 may be instantiated by programmable circuitry such as the example programmable circuitry 2112 of FIG. 21. For instance, the main incremental angle determination circuitry 402 may be instantiated by executing machine executable instructions such as those implemented by at least block 2002 of FIG. 20. Additionally or alternatively, the main incremental angle determination circuitry 402 may be instantiated by any other combination of hardware, software, and/or firmware. For example, the main incremental angle determination circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for generating the VBC angle request includes means for determining a derivative incremental angle. For example, the means for determining the derivative incremental angle may be implemented by derivative incremental angle determination circuitry 404. In some examples, the derivative incremental angle determination circuitry 404 may be instantiated by programmable circuitry such as the example programmable circuitry 2112 of FIG. 21. For instance, the derivative incremental angle determination circuitry 404 may be instantiated by executing machine executable instructions such as those implemented by at least block 2004 of FIG. 20. Additionally or alternatively, the derivative incremental angle determination circuitry 404 may be instantiated by any other combination of hardware, software, and/or firmware. For example, the derivative incremental angle determination circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for generating the VBC angle request includes means for determining a return to center (R2C) incremental angle. For example, the means for determining the R2C incremental angle may be implemented by R2C incremental angle determination circuitry 406. In some examples, the R2C incremental angle determination circuitry 406 may be instantiated by programmable circuitry such as the example programmable circuitry 2112 of FIG. 21. For instance, the R2C incremental angle determination circuitry 406 may be instantiated by executing machine executable instructions such as those implemented by at least blocks 1806 of FIGS. 18 and 2008 of FIG. 20. Additionally or alternatively, the R2C incremental angle determination circuitry 406 may be instantiated by any other combination of hardware, software, and/or firmware. For example, the R2C incremental angle determination circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for generating the VBC angle request includes means for determining a damping incremental angle. For example, the means for determining the damping incremental angle may be implemented by damping incremental angle determination circuitry 408. In some examples, the damping incremental angle determination circuitry 408 may be instantiated by programmable circuitry such as the example programmable circuitry 2112 of FIG. 21. For instance, the damping incremental angle determination circuitry 408 may be instantiated by executing machine executable instructions such as those implemented by at least block 2010 of FIG. 20. Additionally or alternatively, the damping incremental angle determination circuitry 408 may be instantiated by any other combination of hardware, software, and/or firmware. For example, the damping incremental angle determination circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for generating the VBC angle request includes means for combining the main incremental angle, the derivative incremental angle, the R2C incremental angle, the damping incremental angle, and a current steering wheel angle (SWA). For example, the means for combining may be implemented by VBC angle determination circuitry 410. In some examples, the VBC angle determination circuitry 410 may be instantiated by programmable circuitry such as the example programmable circuitry 2112 of FIG. 21. For instance, the VBC angle determination circuitry 410 may be instantiated by executing machine executable instructions such as those implemented by at least blocks 2012, 2014 of FIG. 20. Additionally or alternatively, the VBC angle determination circuitry 410 may be instantiated by any other combination of hardware, software, and/or firmware. For example, the VBC angle determination circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the steering controller 204 includes means for determining an angle blending weight. For example, the means for determining the angle blending weight may be implemented by angle blending weight determination circuitry 502. In some examples, the angle blending weight determination circuitry 502 may be instantiated by programmable circuitry such as the example programmable circuitry 2112 of FIG. 21. For instance, the angle blending weight determination circuitry 502 may be instantiated by executing machine executable instructions such as those implemented by at least block 1810 of FIG. 18. Additionally or alternatively, the angle blending weight determination circuitry 502 may be instantiated by any other combination of hardware, software, and/or firmware. For example, the angle blending weight determination circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the steering controller 204 includes means for determining a final angle request. For example, the means for determining the final angle request may be implemented by final angle determination circuitry 504. In some examples, the final angle determination circuitry 504 may be instantiated by programmable circuitry such as the example programmable circuitry 2112 of FIG. 21. For instance, the final angle determination circuitry 504 may be instantiated by executing machine executable instructions such as those implemented by at least block 1812 of FIG. 18. Additionally or alternatively, the final angle determination circuitry 504 may be instantiated by any other combination of hardware, software, and/or firmware. For example, the final angle determination circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the steering controller 204 includes means for converting the final angle request to a torque request. For example, the means for converting may be implemented by conversion circuitry 308. In some examples, the conversion circuitry 308 may be instantiated by programmable circuitry such as the example programmable circuitry 2112 of FIG. 21. For instance, the conversion circuitry 308 may be instantiated by executing machine executable instructions such as those implemented by at least blocks 1814 and 1816 of FIG. 18. Additionally or alternatively, the conversion circuitry 308 may be instantiated by any other combination of hardware, software, and/or firmware. For example, the conversion circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the ECU 202 of FIGS. 2A-2B is illustrated in FIG. 3, one or more of the elements, processes, and/or devices illustrated in FIG. 3 may be combined, divided, re-arranged, omitted, eliminated, and/or implemented in any other way. Further, the example steering controller 204, the example VBC circuitry 302, the example PF circuitry 304, the example PF conditioning circuitry 305, the example angle blending circuitry 306, the example conversion circuitry 308, the example main incremental angle determination circuitry 402, the example derivative incremental angle determination circuitry 404, the example R2C incremental angle determination circuitry 406, the example damping incremental angle determination circuitry 408, the VBC angle determination circuitry 410, the example angle blending weight determination circuitry 502, the example final angle determination circuitry 504, and/or, more generally, the example steering controller 204 of FIGS. 2A-2B, may be implemented by hardware alone or by hardware in combination with software and/or firmware. Thus, for example, any of the example VBC circuitry 302, the example PF circuitry 304, the example angle blending circuitry 306, the example conversion circuitry 308, the example main incremental angle determination circuitry 402, the example derivative incremental angle determination circuitry 404, the example R2C incremental angle determination circuitry 406, the example damping incremental angle determination circuitry 408, the VBC angle determination circuitry 410, the example angle blending weight determination circuitry 502, the example final angle determination circuitry 504, the torque filtering circuitry 1602, the direction dismissing circuitry 1604, the noise filtering circuitry 1606, the addition circuitry 1608, the integration circuitry 1610, the leakage circuitry 1612, and the conditioned PF angle calculation circuitry 1614, and/or, more generally, the example ECU 202, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example ECU 202 of FIGS. 2A-2B may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed by programmable circuitry to implement and/or instantiate the ECU 202 of FIGS. 2A-2B and/or representative of example operations which may be performed by programmable circuitry to implement and/or instantiate the ECU 202, are shown in FIGS. 18, 19, and/or 20. The machine readable instructions may be one or more executable programs or portion(s) of one or more executable programs for execution by programmable circuitry such as the programmable circuitry 2112 shown in the example processor platform 2100 discussed below in connection with FIG. 21 and/or may be one or more function(s) or portion(s) of functions to be performed by other example programmable circuitry, such as an FPGA. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 18, 19, and/or 20, many other methods of implementing the example ECU 202 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 18, 19, and/or 20 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 18 is a flowchart representative of example machine readable instructions and/or example operations 1800 that may be executed, instantiated, and/or performed by programmable circuitry to adjust a steering angle of a vehicle. The example operation of FIG. 18 assumes the vehicle 100 is in the self-driving mode. The example machine-readable instructions and/or the example operations 1800 of FIG. 16 begin at blocks 1802, at which the ECU 202 (FIGS. 2A-2B) accesses or obtains the PF angle request, the torque input, and the current SWA. For example, the PF conditioning circuitry 305 can query the PF circuitry 304 for an instantaneous PF angle request. The VBC circuitry 302 and/or the PF conditioning circuitry 305 can access an output of the torque sensor 222 (FIGS. 2A-2B) and determine a torque input based on the sensor output (as discussed above in connection with blocks 1602, 1606). The VBC circuitry 302 and/or the PF conditioning circuitry 305 can access the current SWA from the SWA sensor 224.

At block 1804, the ECU 202 conditions the PF angle request. For example, the PF conditioning circuitry 305 can condition the instantaneous PF angle request output by the PF circuitry 304 based on the instantaneous SWA and the torque input. In some examples, the PF conditioning circuitry 305 executes and/or performs the example operations 1700 of FIG. 17 to determine a conditioned PF angle request. Further details regarding block 1804 are described below in connection with FIG. 19.

At block 1806, the ECU 202 generates the VBC angle request. For example, the VBC circuitry 302 determines various incremental angles and combines them with the current SWA to generate the VBC angle request. Further details regarding block 1806 are described below in connection with FIG. 20.

At block 1808, the ECU 202 determines an angle blending weight. For example, the angle blending circuitry 306 and/or the angle blending weight determination circuitry 502 computes the angle blending weight based on the driver input torque and the vehicle speed. In some examples, the angle blending weight circuitry 306 and or the angle blending weight determination circuitry 502 executes and/or performs the example operations 700 of FIG. 7 to determine the angle blending weight.

At block 1810, the ECU 202 determines a final angle request. For example, the angle blending circuitry 306 and/or the final angle determination circuitry 504 blends the VBC angle request, the conditioned PF angle request, and the angle blending weight to calculate the final angle request. In some examples, the angle blending weight circuitry 306 and or the final angle determination circuitry 504 executes and/or performs the example operations 900 of FIG. 9 to determine the final angle request.

At block 1812, the ECU 202 converts the final angle request to a torque request. For example, the conversion circuitry 308 of FIG. 3 calculates the torque that would cause the steering wheel 206 to rotate or turn to the steering angle associated with the final angle request.

At block 1814, the ECU 202 causes the motor 214 (FIG. 2A) or the first steerable wheel motor 252 (FIG. 2B), the second steerable wheel motor 254 (FIG. 2B), and/or the torque feedback motor 260 to apply the torque request on the steering system 200, 250 (e.g., on the rack 212, on the steerable wheels 218, 220, on the steering wheel 206) of the vehicle 100 to achieve the final angle request. For example, the conversion circuitry 308 sends the torque request to the motor 214 with a command to apply the torque request to the gear rack 212, which thereby adjusts the steering angle of the vehicle 100 to the steering angle associated with the final angle request. Alternatively, the conversion circuitry 408 can send the torque request to the first steerable wheel motor 252 and the second steerable wheel motor 254, which thereby adjust the steering angle of the vehicle 100 to the steering angle associated with the final angle request. In some examples, the conversion circuitry 408 sends the torque request to the torque feedback motor 260, which adjusts the SWA and/or a torque provided to the steering wheel 206 based on the steering angle associated with the final angle request.

In some examples, control proceeds back to block 1802 and the ECU 202 continues to monitor for additional torque input, such as when the driver is applying torque to the steering wheel 206. The example process may be repeated continuously while the vehicle 100 is in the self-driving mode. However, if the self-driving mode is deactivated and/or the vehicle 100 is turned off, the example process and/or operation 1800 ends.

FIG. 19 is a flowchart representative of example machine readable instructions and/or example operations 1900 that may be executed, instantiated, and/or performed by programmable circuitry to generate the conditioned PF angle request. The example machine-readable instructions and/or the example operations 1900 of FIG. 19 may correspond to the operation(s) performed at block 1804 of FIG. 18. The example machine-readable instructions and/or the example operations 1900 of FIG. 19 begin at block 1902, at which the ECU 202 bandpass filters the torque input. For example, the PF conditioning circuitry 305 can bandpass filter the torque input detected by the torque sensor 222. In some examples, the torque filtering circuitry 1602 bandpass filters the torque input.

At block 1904, the ECU 202 computes the absolute value of the filtered torque. For example, the PF conditioning circuitry 305 can compute the absolute value of the filtered torque. In some examples, the direction dismissing circuitry 1604 computes the absolute value of the filtered torque.

At block 1906, the ECU 202 applies a torque threshold to the filtered torque. For example, the PF conditioning circuitry 305 can determine whether the filtered torque is greater than or equal to a torque amplitude threshold (e.g., 0.1). In some examples, the noise filtering circuitry 1606 determines whether the filtered torque satisfies a threshold. When the filtered torque does not satisfy (e.g., is less than or equal to, is less than) the threshold, the noise filtering circuitry 1606 changes the filtered torque to zero (e.g., an amplitude of zero) and transmits the zero amplitude to the addition circuitry 1608. Otherwise, when the filtered torque satisfies (e.g., is greater than, is greater than or equal to) the threshold, the noise filtering circuitry 1606 passes the filtered torque amplitude to the addition circuitry 1608.

At block 1908, the ECU 202 applies a leakage to the filtered torque. For example, the PF conditioning circuitry 305 can subtract the leakage from the filtered torque. In some examples, the leakage circuitry 1612 (FIG. 16) determines the leakage, and the addition circuitry 1608 (FIG. 16) applies the leakage to the filtered torque.

At block 1910, the ECU 202 integrates the filtered torque with the leakage applied to obtain a driver demand weight. For example, the PF conditioning circuitry 305 can compute an integral of the filtered torque with the leakage applied to obtain the driver demand weight. In some examples, the integration circuitry 1610 integrates the filtered torque with the leakage applied.

At block 1912, the ECU 202 conditions the PF angle request. For example, the PF conditioning circuitry 305 can compute the conditioned PF angle request based on the driver demand weight, the instantaneous SWA, and the instantaneous PF angle. In some examples, the conditioned PF angle calculation circuitry 1614 calculates the conditioned PF angle request using Equation 1.

At block 1914, the PF conditioning 305 outputs the conditioned PF angle request for angle blending. For example, the conditioned PF angle calculation circuitry 1614 can transmit the conditioned PF angle request to the angle blending circuitry 306 (FIG. 3). As such, the angle blending circuitry 306 can utilize the conditioned PF angle request to determine a final angle request to be delivered to the angle controller 309 (e.g., a torque request to be delivered to the motor 214).

FIG. 20 is a flowchart representative of example machine readable instructions and/or example operations 2000 that may be executed, instantiated, and/or performed by programmable circuitry to generate the VBC angle request. The example machine-readable instructions and/or the example operations 2000 of FIG. 20 may correspond to the operation(s) performed at block 1806 of FIG. 18. The example machine-readable instructions and/or the example operations 2000 of FIG. 20 begin at block 2002, at which the steering controller 204 (FIGS. 2A-2B) determines a main torque based incremental angle. For example, the VBC circuitry 302 (FIG. 3) and/or the main incremental angle determination circuitry 402 of FIG. 4 determines the main incremental angle based on the operations 1000 of FIG. 10.

At block 2004, the steering controller 204 (FIGS. 2A-2B) determines a torque derivative based incremental angle. For example, the VBC circuitry 302 (FIG. 3) and/or the derivative incremental angle determination circuitry 404 of FIG. 4 determines the derivative incremental angle based on the operations 1100 of FIG. 11.

At block 2006, the steering controller 204 (FIGS. 2A-2B) determines an R2C reference. For example, the VBC circuitry 302 (FIG. 3) and/or the R2C angle determination circuitry 406 of FIG. 4 determines the R2C reference based on the operations 1400 of FIG. 14.

At block 2008, the steering controller 204 (FIGS. 2A-2B) determines an R2C incremental angle. For example, the VBC circuitry 302 (FIG. 3) and/or the R2C angle determination circuitry 406 of FIG. 4 determines the R2C incremental angle based on the operations 1300 of FIG. 13.

At block 2010, the steering controller 204 (FIGS. 2A-2B) determines a steering wheel damping incremental angle. For example, the VBC circuitry 302 (FIG. 3) and/or the damping incremental angle determination circuitry 408 of FIG. 4 determines the damping incremental angle based on the operations 1500 of FIG. 15.

At block 2012, the steering controller 204 (FIGS. 2A-2B) combines the main incremental angle, the derivative incremental angle, the R2C incremental angle, and the damping incremental angle. For example, the VBC circuitry 302 (FIG. 3) and/or the VBC angle determination circuitry 410 of FIG. 4 combines the incremental angles based on the operations 900 of FIG. 9.

At block 2014, the steering controller 204 (FIGS. 2A-2B) sums the combination of block 2012 with the current SWA. For example, the VBC circuitry 302 (FIG. 3) and/or the VBC angle determination circuitry 410 of FIG. 4 adds the combination to the current SWA based on the operations 900 of FIG. 9. After block 2014, control returns to block 1808 of FIG. 18.

FIG. 21 is a block diagram of an example programmable circuitry platform 2100 structured to execute and/or instantiate the example machine-readable instructions and/or the example operations of FIGS. 18, 19, and/or 20 to implement the ECU 202 of FIGS. 2A-2B. The programmable circuitry platform 2100 can be, for example, an electronic or engine control unit (ECU) of a vehicle, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, or any other type of computing and/or electronic device.

The programmable circuitry platform 2100 of the illustrated example includes programmable circuitry 2112. The programmable circuitry 2112 of the illustrated example is hardware. For example, the programmable circuitry 2112 can be implemented by one or more integrated circuits, logic circuits, FPGAs, microprocessors, CPUs, GPUs, DSPs, and/or microcontrollers from any desired family or manufacturer. The programmable circuitry 2112 may be implemented by one or more semiconductor based (e.g., silicon based) devices. In this example, the programmable circuitry 2112 implements the steering controller 204, the example VBC circuitry 302, the example PF circuitry 304, the example PF conditioning circuitry 305, the example angle blending circuitry 306, the example conversion circuitry 308, the example main incremental angle determination circuitry 402, the example derivative incremental angle determination circuitry 404, the example R2C incremental angle determination circuitry 406, the example damping incremental angle determination circuitry 408, the VBC angle determination circuitry 410, the example angle blending weight determination circuitry 502, the example final angle determination circuitry 504, the example torque filtering circuitry 1602, the example direction dismissing circuitry 1604, the example noise filtering circuitry 1606, the addition circuitry 1608, the example integration circuitry 1610, the example leakage circuitry 1612, and the example conditioned PF angle calculation circuitry 1614, and/or, more generally, the example ECU 202.

The programmable circuitry 2112 of the illustrated example includes a local memory 2113 (e.g., a cache, registers, etc.). The programmable circuitry 2112 of the illustrated example is in communication with main memory 2114, 2116, which includes a volatile memory 2114 and a non-volatile memory 2116, by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117. In some examples, the memory controller 2117 may be implemented by one or more integrated circuits, logic circuits, microcontrollers from any desired family or manufacturer, or any other type of circuitry to manage the flow of data going to and from the main memory 2114, 2116.

The programmable circuitry platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2122 are connected to the interface circuitry 2120. The input device(s) 2122 permit(s) a user (e.g., a human user, a machine user, etc.) to enter data and/or commands into the programmable circuitry 2112. The input device(s) 2122 may include the torque sensor 222, the SWA sensor 224, the speed sensor 311, the first steerable wheel position sensor 256, and/or the second steerable wheel position sensor 258. Additionally or alternatively, the input device(s) 2122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2124 are also connected to the interface circuitry 2120 of the illustrated example. The output device(s) 2124 can include the motor 214, the first steerable wheel motor 252, the second steerable wheel motor 254, and/or the torque feedback motor 260. Additionally or alternatively, the output device(s) 2124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2100 of the illustrated example also includes one or more mass storage discs or devices 2128 to store firmware, software, and/or data. Examples of such mass storage discs or devices 2128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 2132, which may be implemented by the machine readable instructions of FIGS. 18, 19, and/or 20, may be stored in the mass storage device 2128, in the volatile memory 2114, in the non-volatile memory 2116, and/or on at least one non-transitory computer readable storage medium such as a CD or DVD which may be removable.

From the foregoing, it will be appreciated that example systems, apparatus, articles of manufacture, and methods have been disclosed that adjust the steering wheel angle of a vehicle. Disclosed systems, apparatus, articles of manufacture, and methods adjust a torque pushback provided to a steering wheel based on a torque input that the driver provides to minimize or otherwise reduce undesired torque pushback (e.g., when the driver is performing dynamic maneuvers). Disclosed systems, apparatus, articles of manufacture, and methods improve the efficiency of using a computing device and a steering system of a vehicle by enabling an angle control interface for an angle based self-driving control system of the vehicle. Disclosed systems, apparatus, articles of manufacture, and methods are accordingly directed to one or more improvement(s) in the operation of a machine such as a computer or other electronic and/or mechanical device.

Examples and combinations of examples disclosed herein include the following:
Example 1 includes a vehicle comprising a steering wheel, a torque sensor operatively coupled to the steering wheel, the torque sensor to sense a torque input to the steering wheel by a driver, a steerable wheel, the steering wheel operatively coupled to the steerable wheel, a steering motor to be activated to control a steering angle of the steering wheel while the vehicle is in an assisted driving mode, and programmable circuitry to execute instructions to access a path follower (PF) angle request, condition the PF angle request to obtain a conditioned PF angle request based on the torque input, determine a final angle request based on the conditioned PF angle request, and convert the final angle request to a torque request to be used to adjust the steering angle via the steering motor.
Example 2 includes the vehicle of any preceding example, wherein, to condition the PF angle request, the programmable circuitry is to determine a weight based on the torque input, the weight to configure a first effect of the steering angle on the final angle request and a second effect of the PF angle request on the final angle request.
Example 3 includes the vehicle of any preceding example, wherein, to determine the final angle request, the programmable circuitry is to sum (i) the first effect multiplied by the steering angle and (ii) the second effect multiplied the PF angle request.
Example 4 includes the vehicle of any preceding example, wherein, to condition the PF angle request, the programmable circuitry is to band pass filter the torque input.
Example 5 includes the vehicle of any preceding example, wherein band pass filtering the torque input provides a filtered torque input, and wherein, to condition the PF angle request, the programmable circuitry is to determine whether an absolute value of the filtered torque input satisfies a threshold, and when the absolute value of the filtered torque input does not satisfy the threshold, cause the conditioned PF angle request to be equivalent to the PF angle request.
Example 6 includes the vehicle of any preceding example, wherein, when the absolute value of the filtered torque input satisfies the threshold, the programmable circuitry is to add a leakage to the absolute value of the filtered torque input to obtain a conditioned torque input, determine an integral of the conditioned torque input, and determine the conditioned PF angle request based on the integral.
Example 7 includes the vehicle of any preceding example, further including a steering wheel angle (SWA) sensor operatively coupled to the steering wheel, the SWA sensor to sense the SWA, wherein, to determine the conditioned PF angle request, the programmable circuitry is to determine a weight to be applied to the PF angle request and the SWA based on the integral, multiply the SWA by the weight to obtain a first value, multiply the PF angle request by the weight subtracted from one to obtain a second value, and sum the first value and the second value to obtain the conditioned PF angle request.
Example 8 includes the vehicle of any preceding example, wherein the leakage reduces the absolute value of the filtered torque input to cause the integral to move towards zero when the torque input is zero.
Example 9 includes the vehicle of any preceding example, wherein the programmable circuitry is to generate a virtual boost curve (VBC) angle request based on the torque input to the steering wheel by the driver, and determine an angle blending weight based on the torque input and a speed of the vehicle, wherein the final angle request is determined based on the VBC angle and the angle blending weight.
Example 10 includes a non-transitory machine readable storage medium comprising instructions to cause programmable circuitry to at least access a path follower (PF) angle request, condition the PF angle request to obtain a conditioned PF angle request based on a torque input to a steering wheel by a driver of a vehicle, determine a final angle request based on the conditioned PF angle request, and convert the final angle request to a torque request to adjust a steering angle of the steering wheel while the vehicle is in an assisted driving mode.
Example 11 includes the non-transitory machine readable storage medium of any preceding example, wherein, to condition the PF angle request, the instructions are to cause programmable circuitry to determine a weight based on the torque input, the weight to configure a first effect of the steering angle on the final angle request and a second effect of the PF angle request on the final angle request.
Example 12 includes the non-transitory machine readable storage medium of any preceding example, wherein, to determine the final angle request, the instructions are to cause programmable circuitry to sum (i) the first effect multiplied by the steering angle and (ii) the second effect multiplied by the PF angle request.
Example 13 includes the non-transitory machine readable storage medium of any preceding example, wherein, to condition the PF angle request, the instructions are to cause the programmable circuitry to band pass filter the torque input to obtain a filtered torque input, determine whether an absolute value of the filtered torque input satisfies a threshold, and when the absolute value of the filtered torque input does not satisfy the threshold, cause the conditioned PF angle request to be equivalent to the PF angle request.
Example 14 includes the non-transitory machine readable storage medium of any preceding example, wherein, when the absolute value of the filtered torque input satisfies the threshold, the instructions are to cause the programmable circuitry to add a leakage to the absolute value of the filtered torque input to obtain a conditioned torque input, determine an integral of the conditioned torque input, and determine the conditioned PF angle request based on the integral.
Example 15 includes the non-transitory machine readable storage medium of any preceding example, wherein, to determine the conditioned PF angle request, the instructions are to cause the programmable circuitry to determine a weight to be applied to the PF angle request and a steering wheel angle (SWA) encountered at the steering wheel based on the integral, multiply the SWA by the weight to obtain a first value, multiply the PF angle request by the weight subtracted from one to obtain a second value, and sum the first value and the second value to obtain the conditioned PF angle request.
Example 16 includes a method comprising conditioning a path follower (PF) angle request to obtain a conditioned PF angle request based on a torque input to a steering wheel by a driver of a vehicle, determining a final angle request based on the conditioned PF angle request, and converting the final angle request to a torque request to be used to adjust a steering angle of the steering wheel while the vehicle is in an assisted driving mode.
Example 17 includes the method of any preceding example, to condition the PF angle request, further including determining a weight based on the torque input, the weight to configure a first effect of the steering angle on the final angle request and a second effect of the PF angle request on the final angle request.
Example 18 includes the method of any preceding example, to determine the final angle request, further including summing (i) the first effect multiplied by the steering angle and (ii) the second effect multiplied by the PF angle request.
Example 19 includes the method of any preceding example, to condition the PF angle request, further including band pass filtering the torque input to obtain a filtered torque input, determining whether an absolute value of the filtered torque input satisfies a threshold, when the absolute value of the filtered torque input does not satisfy the threshold, causing the conditioned PF angle request to be equivalent to the PF angle request, when the absolute value of the filtered torque input satisfies the threshold adding a leakage to the absolute value of the filtered torque input to obtain a conditioned torque input, determining an integral of the conditioned torque input, and determining the conditioned PF angle request based on the integral.
Example 20 includes the method of any preceding example, to determine the conditioned PF angle request, further including determining a weight to be applied to the PF angle request and a steering wheel angle encountered by the steering wheel based on the integral, multiplying the SWA by the weight to obtain a first value, multiplying the PF angle request by the weight subtracted from one to obtain a second value, and summing the first value and the second value to obtain the conditioned PF angle request.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a steering wheel;
a torque sensor operatively coupled to the steering wheel, the torque sensor to sense a torque input to the steering wheel by a driver;
a steerable wheel, the steering wheel operatively coupled to the steerable wheel;
a steering motor to be activated to control a steering angle of the steering wheel while the vehicle is in an assisted driving mode; and
programmable circuitry to execute instructions to:
access a path follower (PF) angle request;
condition the PF angle request to obtain a conditioned PF angle request based on the torque input;
determine a final angle request based on the conditioned PF angle request; and
convert the final angle request to a torque request to be used to adjust the steering angle via the steering motor.

2. The vehicle of claim 1, wherein, to condition the PF angle request, the programmable circuitry is to determine a weight based on the torque input, the weight to configure a first effect of the steering angle on the final angle request and a second effect of the PF angle request on the final angle request.

3. The vehicle of claim 2, wherein, to determine the final angle request, the programmable circuitry is to sum (i) the first effect multiplied by the steering angle and (ii) the second effect multiplied the PF angle request.

4. The vehicle of claim 1, wherein, to condition the PF angle request, the programmable circuitry is to band pass filter the torque input.

5. The vehicle of claim 4, wherein band pass filtering the torque input provides a filtered torque input, and wherein, to condition the PF angle request, the programmable circuitry is to:
determine whether an absolute value of the filtered torque input satisfies a threshold; and
when the absolute value of the filtered torque input does not satisfy the threshold, cause the conditioned PF angle request to be equivalent to the PF angle request.

6. The vehicle of claim 5, wherein, when the absolute value of the filtered torque input satisfies the threshold, the programmable circuitry is to:
add a leakage to the absolute value of the filtered torque input to obtain a conditioned torque input;
determine an integral of the conditioned torque input; and
determine the conditioned PF angle request based on the integral.

7. The vehicle of claim 6, further including a steering wheel angle (SWA) sensor operatively coupled to the steering wheel, the SWA sensor to sense the SWA, wherein, to determine the conditioned PF angle request, the programmable circuitry is to:
determine a weight to be applied to the PF angle request and the SWA based on the integral;
multiply the SWA by the weight to obtain a first value;
multiply the PF angle request by the weight subtracted from one to obtain a second value; and
sum the first value and the second value to obtain the conditioned PF angle request.

8. The vehicle of claim 6, wherein the leakage reduces the absolute value of the filtered torque input to cause the integral to move towards zero when the torque input is zero.

9. The vehicle of claim 1, wherein the programmable circuitry is to:
generate a virtual boost curve (VBC) angle request based on the torque input to the steering wheel by the driver; and
determine an angle blending weight based on the torque input and a speed of the vehicle, wherein the final angle request is determined based on the VBC angle and the angle blending weight.

10. A non-transitory machine readable storage medium comprising instructions to cause programmable circuitry to at least:
access a path follower (PF) angle request;
condition the PF angle request to obtain a conditioned PF angle request based on a torque input to a steering wheel by a driver of a vehicle;
determine a final angle request based on the conditioned PF angle request; and
convert the final angle request to a torque request to adjust a steering angle of the steering wheel while the vehicle is in an assisted driving mode.

11. The non-transitory machine readable storage medium of claim 10, wherein, to condition the PF angle request, the instructions are to cause programmable circuitry to determine a weight based on the torque input, the weight to configure a first effect of the steering angle on the final angle request and a second effect of the PF angle request on the final angle request.

12. The non-transitory machine readable storage medium of claim 11, wherein, to determine the final angle request, the instructions are to cause programmable circuitry to sum (i) the first effect multiplied by the steering angle and (ii) the second effect multiplied by the PF angle request.

13. The non-transitory machine readable storage medium of claim 10, wherein, to condition the PF angle request, the instructions are to cause the programmable circuitry to:
band pass filter the torque input to obtain a filtered torque input;
determine whether an absolute value of the filtered torque input satisfies a threshold; and
when the absolute value of the filtered torque input does not satisfy the threshold, cause the conditioned PF angle request to be equivalent to the PF angle request.

14. The non-transitory machine readable storage medium of claim 13, wherein, when the absolute value of the filtered torque input satisfies the threshold, the instructions are to cause the programmable circuitry to:
add a leakage to the absolute value of the filtered torque input to obtain a conditioned torque input;
determine an integral of the conditioned torque input; and
determine the conditioned PF angle request based on the integral.

15. The non-transitory machine readable storage medium of claim 14, wherein, to determine the conditioned PF angle request, the instructions are to cause the programmable circuitry to:
determine a weight to be applied to the PF angle request and a steering wheel angle (SWA) encountered at the steering wheel based on the integral;
multiply the SWA by the weight to obtain a first value;
multiply the PF angle request by the weight subtracted from one to obtain a second value; and
sum the first value and the second value to obtain the conditioned PF angle request.

16. A method comprising:
conditioning a path follower (PF) angle request to obtain a conditioned PF angle request based on a torque input to a steering wheel by a driver of a vehicle;
determining a final angle request based on the conditioned PF angle request; and
converting the final angle request to a torque request to be used to adjust a steering angle of the steering wheel while the vehicle is in an assisted driving mode.

17. The method of claim 16, to condition the PF angle request, further including determining a weight based on the torque input, the weight to configure a first effect of the steering angle on the final angle request and a second effect of the PF angle request on the final angle request.

18. The method of claim 17, to determine the final angle request, further including summing (i) the first effect multiplied by the steering angle and (ii) the second effect multiplied by the PF angle request.

19. The method of claim 16, to condition the PF angle request, further including:
band pass filtering the torque input to obtain a filtered torque input;
determining whether an absolute value of the filtered torque input satisfies a threshold;
when the absolute value of the filtered torque input does not satisfy the threshold, causing the conditioned PF angle request to be equivalent to the PF angle request;
when the absolute value of the filtered torque input satisfies the threshold:
adding a leakage to the absolute value of the filtered torque input to obtain a conditioned torque input;
determining an integral of the conditioned torque input; and
determining the conditioned PF angle request based on the integral.

20. The method of claim 19, to determine the conditioned PF angle request, further including:
determining a weight to be applied to the PF angle request and a steering wheel angle encountered by the steering wheel based on the integral;
multiplying the SWA by the weight to obtain a first value;
multiplying the PF angle request by the weight subtracted from one to obtain a second value; and
summing the first value and the second value to obtain the conditioned PF angle request.
